(19) United States
(12) Patent Application Publication
(10) Pub. No.: US 2026/0287555 A1
(43) Pub. Date: Sep. 24, 2026

(54) SYSTEMS INTEGRATION OF A SURFACE ACOUSTIC WAVE BIOSENSOR FOR POINT-OF-CARE-DIAGNOSTIC USE

(71) Applicant: AVIANA MOLECULAR TECHNOLOGIES, LLC, Orlando, FL (US)

(72) Inventors: Vanaja V. Ragavan, Orlando, FL (US); Anand Tushar Singh, Orlando, FL (US)

(73) Assignee: AVIANA MOLECULAR TECHNOLOGIES, LLC, Orlando, FL (US)

(21) Appl. No.: 19/472,378

(22) PCT Filed: Apr. 5, 2024
(86) PCT No.: PCT/US2024/023381

§ 371 Date: Oct. 3, 2025

Related U.S. Application Data
(60) Provisional application No. 63/494,315, filed on Apr. 5, 2023.

(51) Int. Cl. G01N 29/02; G01N 29/036; G01N 29/24

(52) U.S. Cl. CPC G01N 29/022; G01N 29/036; G01N 29/2462; G01N 2291/02466; G01N 2291/0423

(57) ABSTRACT

A system and method for diagnosing infectious disease using integrated surface acoustic wave sensor technology includes an efficient, low-cost integrated surface acoustic wave (SAW) or bulk acoustic biosensor-based system for point-of-care diagnostics. The SAW or bulk acoustic biosensor, sample receiving portions and interface portions of the system are configured on a disposable cartridge.

### CROSS-REFERENCE TO RELATED APPLICATION

The present application is related to and claims priority under 35 U.S.C. § 119(e) to U.S. Provisional Patent Application No. 63/494,315, entitled “SYSTEMS INTEGRATION OF A SURFACE ACOUSTIC WAVE BIOSENSOR FOR POINT-OF-CARE-DIAGNOSTIC USE,” filed Apr. 5, 2023. The entire contents of the aforementioned patent application is incorporated herein by this reference.

### FIELD OF THE DISCLOSURE

The present disclosure relates to an apparatus and methods for identifying chemicals, toxins, gaseous compounds and/or biomarkers related to disease or wellness of humans or animals, as well as environmental issues including for instance, infectious disease (e.g., bacterial, fungal, parasitic infections, viral infections, etc.), chemotoxins, biotoxins and biomarkers (e.g., Glial Acidic fibrillary protein (GFAP), Ubiquitin carboxy terminal hydrolase (UCL1), troponin, and the like). More particularly, the disclosure relates to integrated (both surface and bulk) acoustic wave sensor systems for detecting biomarkers such as protein or nucleic acids, as well as infectious agents such as bacteria or viruses and whole or parts of eukaryotic cells such as cancer cells. BACKGROUND OF THE DISCLOSURE It is important to detect and analyze infectious disease, biomarkers, etc. of interest to effectively treat patients and prevent severe disease as rapidly as possible at the point of care without loss of crucial time. Currently available diagnostic systems utilize either optical (light), molecular, or electrochemical methods of detection and analysis. Disadvantageously, these systems lack portability and require complex and costly instruments. A further disadvantage of these systems is that they require the use of expensive consumables (e.g., multiple reagents), which require extensive sample processing, and result in low signal sensitivity and specificity. There is an urgent and unmet need for an efficient and accurate point of care diagnostic system that facilitates rapid detection of infectious diseases, biological markers (e.g., amino acids, nucleic acids, and the like), or environmental markers (e.g., gaseous, chemical, liquid, and the like) of interest that are more accurate, portable and rapid and applicable to human, animal, and environmental diagnostics. The detection of biological and chemical agents needs to be conducted in biological material such as plasma, blood, nasal swabs, etc. but also in other mediums such as waste water, potable water, water and liquids obtained from contaminated or non-contaminated environmental sources. Such chemical analytes can include a series of chemicals found in human blood and other fluids, including ions such as sodium, calcium, potassium, and enzymes. Other chemical agents such as Alkaline phosphatase, Alanine aminotransferase (ALT), Aspartate aminotransferase (AST), Bilirubin (total and direct), Blood glucose, Blood urea nitrogen, Calcium (Ca) in blood, Carbon dioxide (bicarbonate), Chloride (CI), Cholesterol and triglycerides, Creatinine and creatinine Clearance, Gamma-glutamyl transferase (GGT), Lactate dehydrogenase Phosphate in blood, Potassium (K) in blood, Sodium (Na) in blood, Total serum protein, and Uric acid in blood may also be used.

### SUMMARY

The present disclosure describes an integrated and mutually dependent system and method for diagnosing infectious disease, such as bacterial, fungal, parasitic infections, viral infections, and infectious disease caused by viruses, such as SARS-COV-2, for example, and many non-infectious biomarkers such as hormones, proteins, nucleotides whole or part of cells etc. amongst many others of biological interest, including determining real time biological binding activity such as real time binding of affinity agents such as antigen antibody binding dynamics in relevant biological materials ex vivo. Source of biological agents could include biological samples and other sources such as waste water, potable water and ground waters. The disclosure also includes utilization of the disclosed sensor for a variety of chemical toxins such as PFAS (per- and polyfluoroalkyl substances) to be detected in a variety of water sources such as waste water, ground water and other carrier samples such as food, devices among other sources, Sources of biologically important chemical substances found in blood can include the following: Alkaline phosphatase, Alanine aminotransferase (ALT), Aspartate aminotransferase (AST), Bilirubin (total and direct), Blood glucose, Blood urea nitrogen, Calcium (Ca) in blood, Carbon dioxide (bicarbonate), Chloride (Cl), Cholesterol and triglycerides, Creatinine and creatinine Clearance, Gamma-glutamyl transferase (GGT), Lactate dehydrogenase Phosphate in blood, Potassium (K) in blood, Sodium (Na) in blood, Total serum protein, Uric acid in blood among others. The disclosed system employs integrated surface acoustic wave sensor technology (also defined previously) in an efficient, low-cost integrated surface acoustic wave (SAW) biosensor based system for point-of-care diagnostic use that is able to reliably identify biological samples having specific infectious agents and/or biomarkers along with an enhanced detection system and the integrated connectors and software to activate such a system and to provide the analytical tools and user interface for accurate biodetection. Small sample volumes not requiring any or much separation techniques enhance the use of these systems at the point of care and remote situations for humans and animals in both resource rich and resource poor settings.

Aspects of the present disclosure include an integrated surface acoustic wave biosensor in a uniplex or multiplex format system for point-of-care diagnostic along with a preferred metallization waveguide (e.g., delay line) and or a different metallization of other elements of the sensor such as interdigitated transducer (IDT) and reflectors, using various metals and a liquid well containing cartridge adapted specifically for this system. The integrated surface acoustic wave biosensor may produce surface or bulk acoustic waves. The system includes a disposable cartridge component and a reusable reader enclosing a specific contact region whereby data is transferred with integrity from the sensor. It also includes the workings of a reusable reader and ability to multiplex the system for multiple uses and multiple sources of biological materials. According to aspects of the present disclosure, the disposable cartridge component includes a sample well (of open or closed configuration) for addition of the biological sample, integrated surface acoustic wave (SAW) biosensor(s), Radio frequency (RF) and pogo pin and other similar connectors to the SAW biosensor, overmold components and gasket(s). The disposable cartridge also includes a cassette for housing the sample well, the SAW biosensor, the RF and pogo pin and other connectors, and overmolds and gasket(s). Out of cartridge systems for sample processing may also be included, as are reagent tubes that contain a number of reagents such as gold nanoparticles and buffers. According to aspects of the present disclosure, the reusable reader includes a RF port(s) to connect to the RF connector(s) that is (are) part of the disposable cartridge component. The RF connector(s) interface with the SAW biosensor(s) via pogo pins or other such direct connectors that are integrated with the disposable cartridge component. The biosensor may be secured to the cartridge via a galvanic connection assembly.

The disposable cartridge may also include an absorbent wicking pad which allows for repeat of fluid allocation and a simple washout. In illustrative embodiments, the disposable cartridge is attached to the sensor utilizing an overmolded gasket or a felt seal. The advantage of the felt seal to cover the IDTs may be preferential as a way to control fluids on the SAW biosensor as it does not apply significant pressure and dampening to the surface. However, any appropriate sealing device (e.g., a gasket, a felt seal, an overmold, a fabricated wall, or the like) will be acceptable. A fabricated wall may be comprised of a silicone rubber material adhered along the perimeter of a sensing area of the integrated acoustic wave biosensor. In another illustrative embodiment, the SAW biosensor includes a sample channel and one or more reference channels, optionally coated with at least one metal. In another embodiment, the biosensor may include at least two contact pads. In another embodiment, the sensor can be multiplexed with multiple waveguides on a single sensor platform and an adapted flow cell to flow over the entire multiplexed system. In another illustrative embodiment, the SAW biosensor can be multiplexed with multiple uniplex sensors in an array and an adapted flow cell to flow over the entire multiplexed system. In another illustrative embodiment, two or more uniplex and/or multiplex SAW biosensors that each have their own open sample well can be combined into one unit for a multi-well cartridge. In another illustrative embodiment, the SAW biosensor includes a piezoelectric crystal base, such as a lithium tantalite crystal base. Another aspect of the present disclosure provides a disposable cartridge component of an integrated surface acoustic wave biosensor system for point-of-care diagnostic use. The integrated acoustic wave biosensor may also include a coded reflector system comprised of one or more metals. The integrated acoustic wave biosensor may also include uniplex or multiplex sensors which generate surface acoustic waves in the range of 50-1000 MHz or bulk acoustic waves in the range of 50-5,000 MHz.

In some instances, the sample added to the well may need to be mixed in order to make sure that the analytes can adequately interact with the SAW biosensor surface. In this case, we propose a closely held but external vibration module which can mix the fluid in an open well cartridge flow cell as needed.

The biological sample may require processing prior to its addition to the sample well on the disposable cartridge. Materials for off cartridge sample preparation includes, but is not limited to, reagent tubes containing buffer solutions, reagents, such as gold nanoparticles, which may be lyophilized or in solution, syringes, and syringe filters.

Another aspect of the present disclosure provides a method for detecting a target analyte in a biological sample using an integrated surface acoustic wave biosensor system. According to aspects of the present disclosure, the method includes steps of providing a disposable cartridge component of the integrated surface acoustic wave biosensor system, providing the biological sample into a sample well of the disposable cartridge component to interact with the propagating SAW to generate a characteristic electrical signal of the biological sample, and detecting the target analyte based on the characteristic electrical signal.

In one aspect, the disclosure provides an integrated acoustic wave biosensor system, which includes, a disposable cartridge component, which includes, a cassette including: a radiofrequency (RF) port configured to receive an RF signal; a well for the addition of a sample in a fluid; an integrated acoustic wave biosensor, wherein the integrated acoustic wave biosensor includes: a piezoelectric base; at least one metal coated channel; a coded reflector system; at least one sensor, at least one set of interdigital transducers (IDTs), and at least two contact pads; a galvanic connection assembly coupled to the integrated biosensor; and a sealing device configured to separate the fluid from the integrated acoustic wave biosensor; wherein, the integrated acoustic wave biosensor is activated an RF source.

In some embodiments, the sealing device is a fabricated wall.

In some embodiments, the fabricated wall is comprised of a silicone rubber material adhered along a perimeter of a sensing area of the integrated acoustic wave biosensor.

In some embodiments, the sealing device is a polymer gasket or a felt seal.

In some embodiments, a layer of PMMA, silane, or silicone dioxide isolates the region comprising the IDTs, one or more waveguides, and a coded reflector system from the fluid and allows for a rubber gasket around the perimeter of the region comprising the IDTs, waveguides, and reflectors of the integrated acoustic wave biosensor.6. The disposable cartridge component of claim 1, wherein the disposable cartridge is configured to be paired with a cartridge reader In some embodiments, the integrated acoustic wave biosensor is a surface wave acoustic biosensor or a bulk wave acoustic biosensor.

In some embodiments, the well leads to a fluid flow over the sensor in a single plex or multiplex format.

In some embodiments, the well is an open well.

In some embodiments, the well is a closed well.

In some embodiments, the coded reflector system is of (HFM) or (OFM) configuration.

In some embodiments, the disposable cartridge further comprises two or three channel sensors or one or more multiplex sensor(s).

In some embodiments, the coded reflector system comprises one or more metals.

In some embodiments, the one or more metals are selected from the group consisting of gold or aluminum.

In some embodiments, unidirectional IDTs are used instead of the coded reflector system.

In some embodiments, the disposable cartridge comprises a felt seal to protect the IDTs and the coded reflector system.

In some embodiments, the one or more sensors are uniplex sensors or multiplex sensors.

In some embodiments, the uniplex or multiplex sensors generate surface acoustic waves in the range of 50-1000 MHz or bulk acoustic waves in the range of 50-5,000 MHz.

In some embodiments, the surface acoustic waves are in the range of 100-600 MHz.

In some embodiments, the surface acoustic waves are in the range of 100-900 MHz.

In some embodiments, the disposable well cartridge system has a wicking pad.

In some embodiments, the disposable well is closed.

In some embodiments, the disposable well is open.

In some embodiments, the gasket is made of polymer or overmolded TPE onto the well.

In some embodiments, the polymer is PDMS, other silicone-based materials or other low durometer polymer materials.

In some embodiments, the biosensor comprises a sample channel and a reference channel and optionally comprising a compensation channel.

In some embodiments, the acoustic wave biosensor has a metallic waveguide comprising one or more metals selected from the group consisting of gold, titanium, chromium, and aluminum.

In another aspect, the disclosure provides a disposable cartridge component of an integrated acoustic wave biosensor system, which includes: a well for the addition of a fluid sample; a cassette comprising an integrated acoustic wave biosensor, a galvanic connection assembly coupled to the integrated acoustic wave biosensor, and a sealing device separating the sensing area from the integrated acoustic wave biosensor; and a docking location on the cassette body configured to couple with a well.

In another aspect, the disclosure provides a method for detecting a target analyte in a biological sample using an integrated acoustic wave biosensor system of claim 1, the method comprising: providing the fluid sample into the well; applying surface acoustic waves to the sample in the well to generate a characteristic electrical signal of the biological sample; and detecting the target analyte based on the characteristic electrical signal.

### BRIEF DESCRIPTION OF THE DRAWINGS

The present disclosure will now be described more fully hereinafter with reference to the accompanying drawings, in which preferred embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout. Other objects, features and advantages of the present disclosure will become apparent from the detailed description of the disclosure, which follows when considered in light of the accompanying drawings.

FIG. 1A presents an exemplary design of a 300 MHz SAW sensor and RF source.

FIG. 1B shows an exemplary design of a 300 MHz SAW sensor, which has been modified with larger metal contact pads and a third channel for temperature compensation.

FIG. 1C shows a side view of the long axis through the center of the sample channel for the exemplary design in FIG. 1A.

FIG. 1D shows a side view of the short axis perpendicular to the channels for the exemplary design in FIG. 1A.

FIG. 1E shows a side view of the long axis through the center of the sample channel for the exemplary design in FIG. 1B.

FIG. 1F shows a side view of the short axis perpendicular to the channels for the exemplary design in FIG. 1B.

FIG. 2 presents a schematic comparison between an exemplary new miniaturized SAW sensor design according to the disclosure and an original SAW sensor design with a coded reflector.

FIG. 3 presents an exemplary design of a multiplexed SAW sensor design with multiple waveguides on a single sensor and a gold metal overlay.

FIG. 4 presents a top perspective view of an exemplary prototype connection assembly of Radio frequency (RF) and pogo pin connectors to the SAW sensor.

FIG. 5 A presents a side view schematic of an exemplary fabricated wall concept for a SAW sensor.

FIG. 5B presents a side view of a schematic of an exemplary layer of PMMA or silicon dioxide for a SAW sensor.

FIG. 5C presents another side view of a schematic of an exemplary layer of PMMA or silicon dioxide for a SAW sensor.

FIG. 6 presents a diagram of an exemplary polydimethylsiloxane (PDMS) gasket.

FIG. 7A presents a bottom perspective view of an exemplary SAW biosensor system with an enclosure comprising an overmolded thermoplastic elastomers (TPE) gasket.

FIG. 7B presents a side view an exemplary design of the felt seal, applied to the surface of a SAW biosensor, and pressed down by a stiff pressing item to provide moderate pressure on the felt.

FIG. 7C shows a top perspective view of an exemplary design of the felt seal applied to the SAW biosensor surface.

FIG. 8A presents a bottom perspective view of an exemplary embodiment of an open well cartridge flow cell.

FIG. 8B presents an exploded view of an exemplary embodiment of an open well cartridge flow cell in accordance to FIG. 8A.

FIG. 8C presents an open well cartridge flow cell connected to a wicking material to wash if needed.

FIG. 8D presents the use of a vibration module which can mix the fluid in the open well cartridge flow cell.

FIG. 9 presents a top perspective view of a multiplexed SAW sensor with multiple waveguides on a single sensor and an adapted flow cell to flow over the entire multiplexed system.

FIG. 10 presents a top perspective view of SAW sensors multiplexed with multiple uniplex sensors in an array and an adapted flow cell to flow over the entire multiplexed system.

FIG. 11 presents a perspective view of two multiplex SAW sensors that each have their own open sample well and are combined into one unit for a multi-well cartridge.

FIG. 12A presents a schematic of an exemplary circuit of the multiplex system.

FIG. 12B presents a schematic of an exemplary circuit of the multiplex system.

FIG. 13 A presents a perspective view of an exemplary embodiment of a SAW biosensor cartridge system.

FIG. 13B presents an exploded view of the exemplary embodiment of the SAW biosensor cartridge system in accordance to FIG. 10A.

FIG. 14A presents a perspective view of another exemplary embodiment of a SAW biosensor cartridge system.

FIG. 14B presents an exploded view of another exemplary embodiment of the SAW biosensor cartridge system in accordance with FIG. 11A.

FIG. 15A presents a perspective view of a further exemplary embodiment of a SAW biosensor cartridge system.

FIG. 15B presents an exploded view of the further exemplary embodiment of the SAW biosensor cartridge system in accordance with FIG. 12A.

FIG. 16 presents a perspective view of an exemplary embodiment of a SAW biosensor cartridge system adapted for collection and detection of gaseous species from the atmosphere.

FIG. 17 presents a perspective view of an exemplary embodiment of a SAW biosensor cartridge system adapted for collection and detection of bioaerosols from the atmosphere.

FIG. 18A presents a perspective view of the disposable cartridge; and

FIG. 18B presents an exploded view of the disposable cartridge.

FIG. 19 presents a data table demonstrating the ability of the system to detect SARS-COV-2 serology in clinical samples.

FIG. 20 presents a data table demonstrating the ability of gold coated surfaces to detect Canine Heart Worm Antigen (CHW) and canine Anti-Mullerian Hormone (AMH).

### DETAILED DESCRIPTION OF THE DISCLOSURE

The present disclosure is based, at least in part, on the discovery that a gold overlay (to attach biological agents) and coded reflector integrated acoustic detection device such as a Surface Acoustic Wave (SAW) device with an optional dual metallization of gold overlay on the waveguide and a different metal such as aluminum on the interdigitated transducers (IDTs) and reflectors for reduction of interdigitated reflection can provide extremely sensitive detection of biomarkers and infectious disease-related antigens (e.g., SARS-COV-2, SARS-COV, MERS-COV, human coronavirus OC43, human coronavirus HKU1, human coronavirus 229E, human coronavirus NL63 and the like) in a sample. Infections afflicting animals, such as canine heart worm, equine viruses and feline viruses, can also be detected. Other examples include antigen driven circulating antibodies, protein biomarkers of interest in wellness and disease and cancer markers on cells and in liquid phase.

Aspects of the present disclosure include platforms, apparatus, and systems that are useful for the identification of biological agents, chemicals, toxins, environmental agents and the like. The disclosed platforms, apparatus, and systems may be used for diagnosis, treatment and/or prevention of any biological event of interest such as cardiac events, neurological events reproductive events, cancer, etc., as well as a variety of infectious diseases such as, e.g., those caused by bacteria, immunological events, fungi, viruses, eukaryotic cells, proteins, nucleotides, and the like. The use of this biosensor is disclosed for human, animal (e.g., companion, wildlife, and food animals), and environmental use. The disclosed apparatus, systems and platforms may be used for detection of non-biological systems, such as chemotoxins and gaseous systems.

The use of acoustic based analysis systems for biosensing (e.g., general methods of acoustic analysis, reflector-based and unidirectional IDT-based surface acoustic waves, bulk acoustic waves, and the like) has previously been proposed but not implemented in various biosensor designs for use in point of care diagnostic systems and detectors. In particular, the techniques herein provide an acoustic wave sensor known as a Surface Acoustic Wave (SAW) sensors, which operate on the principle of passive wireless sensing of a mass/viscosity change using piezoelectricity as a sensing platform, that allows electronic detection of specific parameters when changes to the acoustic wave properties are conveyed as a change in electronic measurements. Piezoelectricity is a phenomenon displayed in certain crystals, such as quartz, lithium niobate, and lithium tantalate, where voltage generation is induced by mechanical stress. Interestingly, the reverse is also true, such that application of voltage will induce a mechanical deformation or stress. The ability of the piezoelectric crystals to undergo atomic vibration in the presence of an electrically generated radio frequency input presents the ability of crystals to function as sensors. SAW sensors are used in the detection of changes in mass, viscoelasticity, conductivity, and dielectric properties derived from mechanical or electrical variations. SAW sensors also employ the piezoelectric effect to excite acoustic waves electrically at an input transducer and to receive the waves at the output transducer.

Previous publications of this applicant have described the use of different coatings, layers, signal amplification, interfaces with fluid materials, connectors of various sorts, cartridges and fluid control systems and multiplexing for use in various sizes of SAW-based biosensors. Examples of such publications include U.S. patent application Ser. No. 16/629,309 filed Jan. 7, 2020, entitled “BIOACTIVE COATING FOR SURFACE ACOUSTIC WAVE SENSOR”; U.S. patent application Ser. No. 16/629,305 filed Jan. 7, 2020, entitled “METHODS AND APPARATUS FOR INTERFACING SENSORS WITH FLUID MATERIALS”; U.S. patent application Ser. No. 16/629,307 filed Jan. 7, 2020, entitled “MULTIPLEXING SURFACE ACOUSTIC WAVE SENSORS WITH DELAY LINE CODING” the disclosures which are hereby incorporated by reference in their entirety.

Piezoelectric crystals, such as quartz, lithium niobate and tantalate, that support surface type acoustic waves are typically only weakly responsive to adequate adhesion of biological materials. Chemical agents such as silane compounds following a series of proprietary application procedures along with reactive functional groups, such as amine residues, have been used to enhance adhesion of biological molecules on the surface crystals.

The disclosure provides techniques for modifying the crystal surface of SAW based biodetectors by applying a layer of gold, silica or aluminum onto the surface of the crystal during fabrication which also serves as a waveguide in directing the acoustic wave in the right orientation in our configuration of a reflected wave. This approach in which the metalized waveguide at least partially coats the surface of the crystal with a metal is more amenable to the attachment of biological molecules. Additionally, it is contemplated within the scope of the disclosure that another metal can be used to construct the IDTs and reflectors. Adding a metal layer such as gold on the crystal surface of a SAW biodetector to serve as a critical waveguide has also been attempted. However, while some metal surfaces are more effective on the surface of the propagating acoustic waves, metals such as aluminum bind biological molecules poorly when placed on the waveguide and are therefore not optimal for use on the surface of SAW detection and diagnostic devices. Biological buffers can etch the aluminum waveguide surfaces, which can adversely affect the propagation of the SAW. The present disclosure provides a preferred metal structure consisting of a gold layer on the reflector-based sensor design and flow cell, optionally including another metal on the IDTs and reflectors more amenable to wave generation, which allows the acoustic wave to propagate effectively and is also significantly compatible with biological capture agents binding to its surface via thiol groups. The gold layer thickness is optimized to reduce the signal-to-noise, which enhances the sensitivity of the SAW. Also demonstrated is early data on the sensitivities of binding and detection of proteins at very low concentrations, a major advantage to our system.

Other approaches to modifying the crystal surface of SAW based biodetectors included applying a layer composed of a dielectric material such as SiO2, Poly (methyl methacrylate), or gold, on the surface of the SAW sensor to further trap the energy of the acoustic wave closer to the surface for enhanced analyte detection. Similarly, a layer of silicon dioxide may enhance the binding ability of biological molecules without interfering with the transmission of the surface wave.

A major disadvantage of previously described SAW based detection and diagnostic systems is due, at least in part, to their inability to effectively bind captured agents onto the surface of acoustically transmissive materials in a liquid environment and to carefully separate the liquid environment from the electronic components. The techniques herein overcome these issues, which provides a fully functional point of care diagnostic system for use in human, animal and research based diagnostic systems.

There remains an urgent world-wide need for a rapid, cost-effective, rapid, portable, sensitive, and robust point of care diagnostic test that can be used for the detection of a variety of biological analytes. In this way, the present disclosure fulfills all of these criteria and furthermore, takes advantage of many recent advances in semi-conductor industry (miniaturization, FPGA, software and hardware advances) and advances in cellular communications (on which these sensors are based) to provide a cost effective and easily used system that can replace 60-year-old technologies such as lateral flow test.

Aspects of the present disclosure address this urgent need and overcome the various disadvantages of previously known systems and methods by providing an efficient, low-cost integrated surface acoustic wave (SAW) biosensor based system and method for point-of-care diagnostic use that is able to reliably identify biological samples having specific agents of interest, both infectious and non-infectious.

In one embodiment of the instant disclosure, an integrated surface biosensor system for the use as a rapid, cost-effective, and robust POC diagnostic for the detection of infectious events, biological agents, and systems is provided.

The techniques herein provide acoustic wave-based POC devices suitable for biological events (e.g. infection agent-virus) systems testing. The acoustic devices and methods described herein utilize a piezoelectric material that responds to an electrical signal by generating an acoustic wave (i.e., very high frequency sound) as the fundamental sensing signal.

In addition to this, multiple biochemical analytes in blood or other body fluids can be simultaneously detected on a single sample channel. This paradigm enables multiplex detection on a uniplex SAW biosensor. For this concept, a cocktail of capture agents that can detect the different biochemical analytes of interest (for example Analytes A, B, C) is coated on the surface of the sample channel. The individual SAW changes in the response time and frequency shift of Analytes A, B, and C need to be known from previous experimentation. The unique relationship between the response time and frequency shift for each analyte is used to deconvolute the identification of Analytes A, B and C when binding to the cocktail of capture agents functionalized to the sample channel. This method assumes that binding of one biochemical does not affect the binding of another.

Aspects of the present disclosure include a disposable cartridge system utilizing a surface acoustic wave (SAW) biosensor with a metallized waveguide of various metals as described that can be used for the detection of biological agents and determine biological binding effects in real time. The cartridge can also include an absorbent wicking pad made of cellulose or the like for washout and repeat of fluid allocation. In addition, a vibration module that is external to the cartridge can provide a method to mix reagents in the flow cell. Fluidic sealing is accomplished using polydimethylsiloxane (PDMS) or the like, thermoplastic elastomers (TPE), or felt seals.

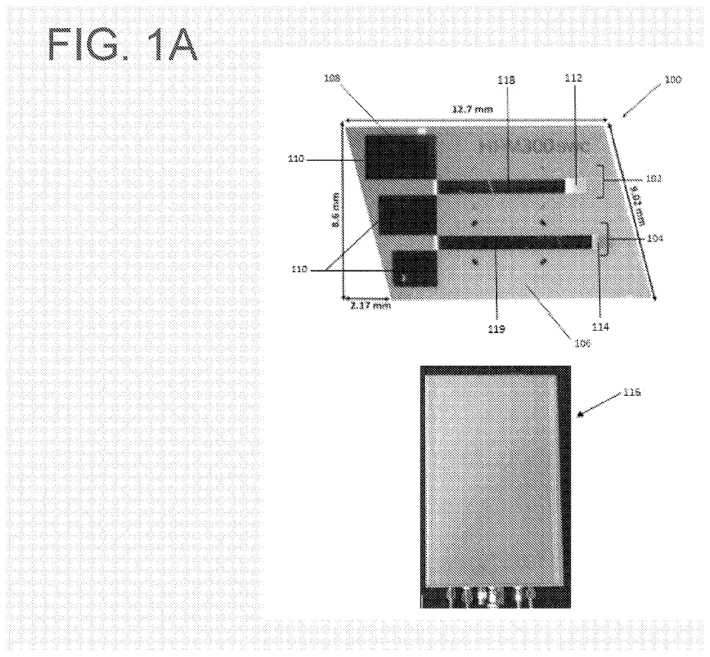

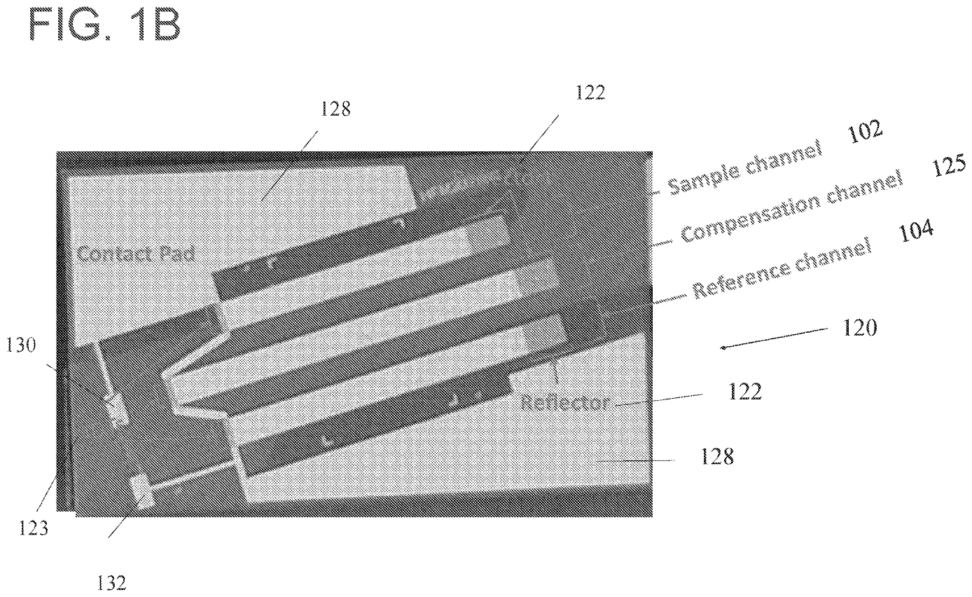

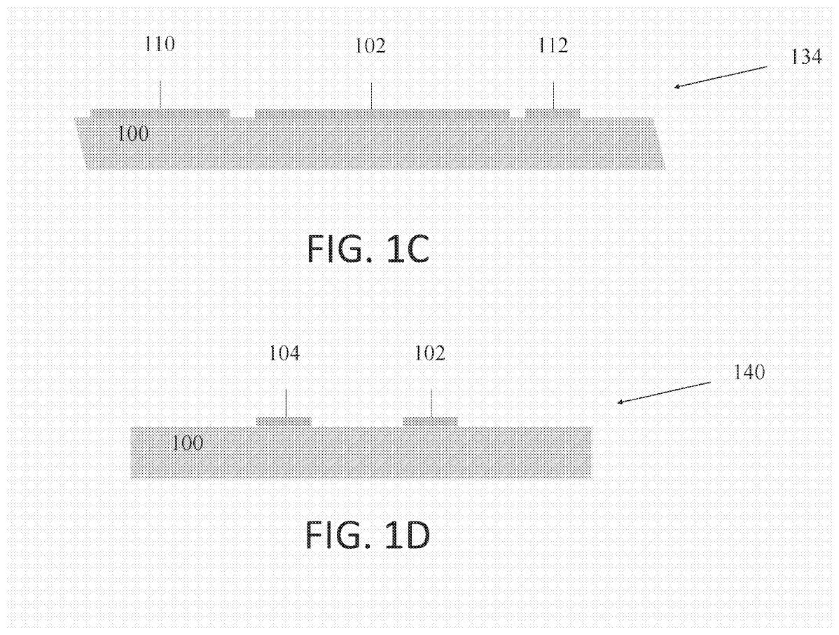

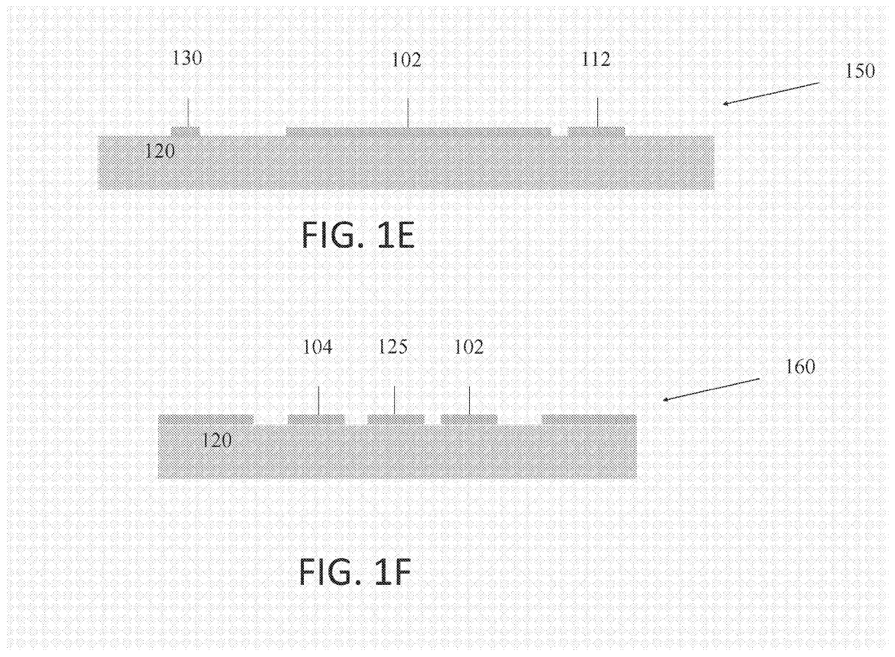

FIG. 1A presents an exemplary design of a 300 MHz (50-999 MHz) SAW biosensor 100. Although this exemplary embodiment describes a 300 MHz sensor, it is to be understood that the surface acoustic waves disclosed herein can have various frequencies ranging from 50-1000 MHz (+/−25 MHz). For example, the frequency of a surface acoustic wave can be about 50, about 100,about 150, about 200, about 250, about 300, about 350, about 400, about 500, about 600, about 700, about 800, about 900, or about 1000 MHz (+/−approximately 25 MHz). Similarly, the frequency of the surface acoustic waves can be less than 100 MHz, greater than 100 MHz, greater than 300 MHz, greater than 500 MHz, or greater than 1000 MHz. The SAW biosensor may be activated by high frequency radiofrequency (RF) waves from a RF source 116. A sample channel reflector 112 and reference channel reflector 114 returns this wave and this is a coded reflector with a hyperbolic frequency modulation (HFM) or orthogonal frequency modulation (OFM). The SAW biosensor 100 comprises a piezoelectric crystal base 106 and one or more metal surfaces 108. In some embodiments, the one or more metal surfaces 108 may be coated with a biofilm. The SAW biosensor 100 may include a sample channel 102 and a reference channel 104. A biological sample may be contacted with the SAW biosensor 100 via the sample channel 102 by dispensing the biological sample with a pipette or dropper into a cartridge flow cell enclosing the SAW biosensor 100 onto which the biological sample may be analyzed.

In some embodiments, sample channel 102 may be coated with one or more capture agents. In further embodiments, the sample channel sensing area 118 and the reference channel area 119 of the SAW device may be a metalized (e.g., Al and/or Au layer) and the piezoelectric crystal base 106 chosen may be, e.g., Lithium tantalate (LiTaO3), lithium niobate (LiNbO3), and quartz. The SAW generated on this crystal may be called a Leaky wave, which may be principally composed of a shear horizontal wave so it can operate in a liquid while keeping a low propagation loss. In some embodiments, a third channel (not shown in the figure) may be added to the SAW biosensor, which serves as a second reference channel to remove the effect of ambient temperature change on the SAW biosensor.

FIG. 1B shows an exemplary design of a 50-999 MHz MHz 3-channel SAW biosensor 120, which has been modified with larger metal contact pads and a third channel for temperature compensation. While the metallization of all the components could be made of gold, it is also possible that the IDTs 123 and reflector 122 could be made of a different metal. The disclosed 3-channel SAW biosensor 120 includes 3-channel contact pads 128 for establishing a connection between the 3-channel SAW biosensor 120 and a printed circuit board (PCB) (not pictured) supporting it. The disclosed 3-channel SAW biosensor 120 includes a sample channel 102 for contacting the biological sample with the 3-channel SAW biosensor 120, a compensation channel 125, and a reference channel 104. The sample channel 102, compensation channel 125, and reference channel 104 each have reflectors 122 and interdigitated transducers (IDTs) 123 for conversion of electrical energy to mechanical energy and vice versa. Probing structure 1 130 and probing structure 2 132 may be used to test the sensors for quality control after fabrication. IDTs 123, reflectors 122, and sample channel 102, compensation channel 125, and reference channel 104 could be made of the same metal or different metals can be used for sample channel 102, compensation channel 125, and reference channel 104 that are biocompatible, such as gold, while a different metal, such as aluminum, could be used for electrical transmission on the IDTs 123 and reflectors 122.

FIG. 1C shows a side view of the long axis 134 through the center of the sample channel 102, contact pad 110, and sample channel reflector 112 of SAW biosensor 100 for the exemplary design in FIG. 1A.

FIG. 1D shows a side view of the short axis 140 perpendicular to the sample channel 102 and the reference channel 104 of SAW biosensor 100 for the exemplary design in FIG. 1A.

FIG. 1E shows a side view of the long axis 150 through the center of the sample channel 112, sample channel reflector 112, and probing structure 1 130 of 3-channel SAW biosensor 120 for the exemplary design in FIG. 1B.

FIG. 1F shows a side view of the short axis 160 perpendicular to sample channel 102, compensation channel 125, and reference channel 104 on 3-channel SAW biosensor 120 for the exemplary design in FIG. 1B.

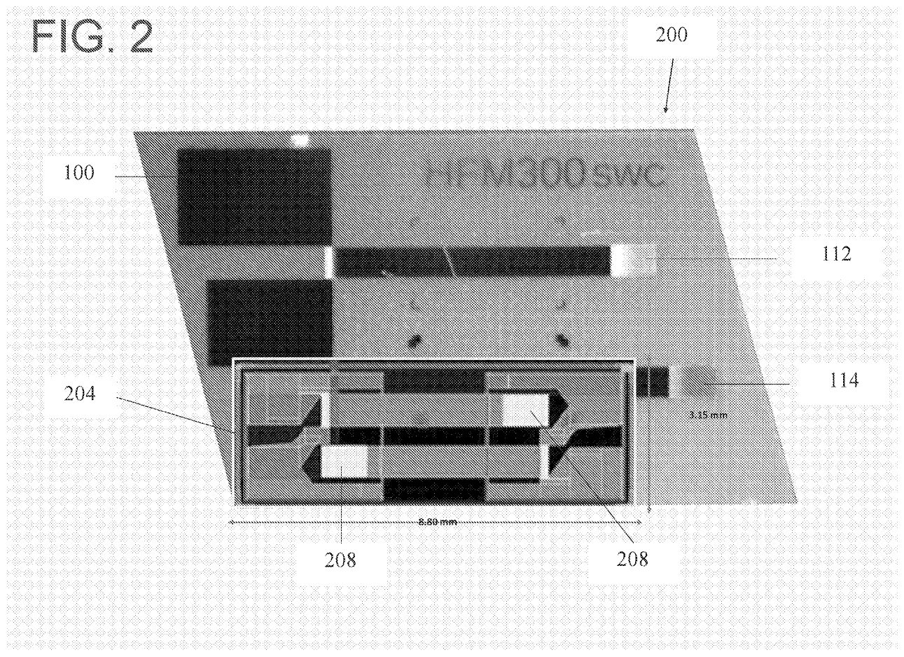

Referring now to FIG. 2, a schematic comparison 200 between a miniaturized SAW biosensor 204 design and the larger SAW biosensor 100 design is presented (frequency range from 50-999 MHz). According to an aspect of the present disclosure, the miniaturized SAW sensor 204 may be designed with a pair of contact pads opposing each other. Miniaturized SAW biosensor 204 has a miniaturized SAW biosensor reflector 208 that is similar to that of the sample channel reflector 112 and reference channel reflector 114 in the larger SAW biosensor design 100.

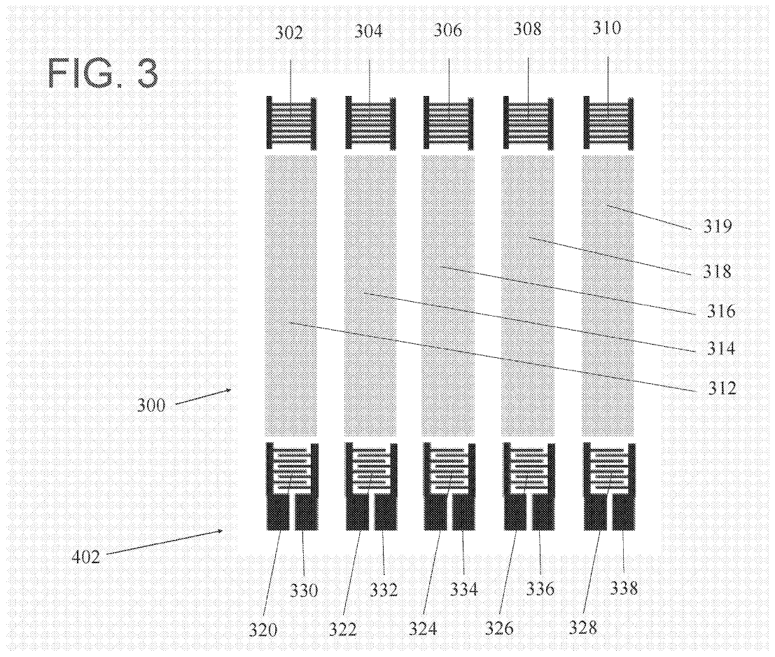

FIG. 3 shows an exemplary design of a multiplexed SAW biosensor 300 design with multiple waveguides on a single sensor and a gold metal overlay. This disclosed multiplexed SAW biosensor 300 has five channels: a first channel 312, a second channel 314, a third channel 316, a fourth channel 318, and a fifth channel 319; four of which may be used as sample channels and one of which may be used as a reference channel. Each channel has reflectors and IDTs for conversion of the electrical energy to mechanical energy and vice versa. This disclosed multiplexed SAW biosensor 300 has five reflectors: a first reflector 302, a second reflector 304, a third reflector 306, a fourth reflector 308, and a fifth reflector 310. The disclosed multiplexed SAW biosensor 300 has five sets of IDTs: a first set of IDTs 320, a second set of IDTs 322, a third set of IDTs 324, a fourth set of IDTs 326, and a fifth set of IDTs 328. A RF connector 402 may interface with a first set of metal contact pads 330, a second set of metal contact pads 332, a third set of metal contact pads 334, a fourth set of metal contact pads 336, and a fifth set of metal contact pads 338 via pogo pins or other such direct connections (not shown in FIG. 3) that are integrated with the disposable cartridge component for interrogation by the reader. As described above, 312-319 may be constructed of a biocompatible metal such as gold while 320-338 are constructed of a different more conductive metal such as aluminum for illustration.

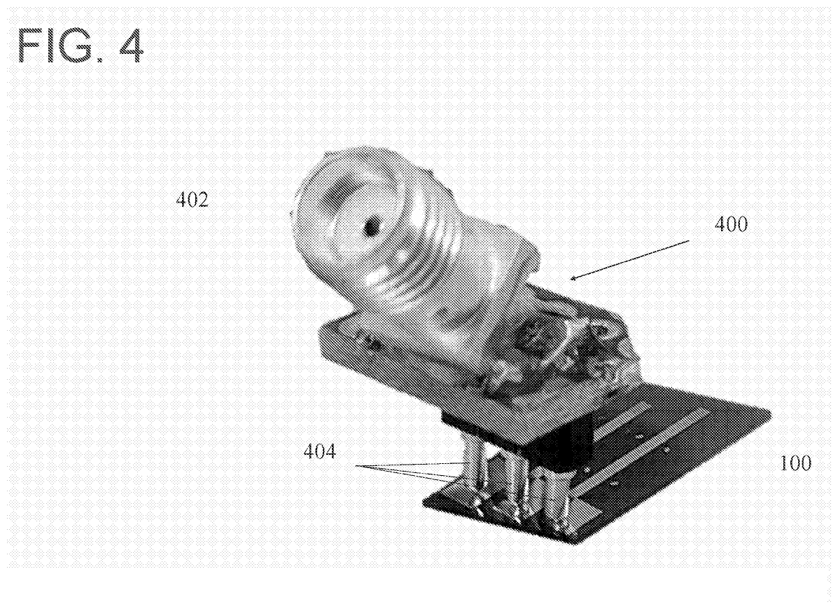

Aspects of the present disclosure further includes a disposable open well (FIG. 4-8) cartridge system utilizing a SAW biosensor, RF and pogo pin connection assembly, fluid gasket, and open well frame that can be used for the detection of infectious agents.

FIG. 4 presents an image of an exemplary prototype connection assembly 400 of RF connector 402 and a pogo pin 404 connector connecting one pogo pin per each channel and a ground pad to the SAW biosensor 100. A RF connector 402 may interface with metal contact pads 110 (shown in FIG. 1A) via pogo pins 404 or other such direct connections that are integrated with the disposable cartridge component for interrogation by the reader.

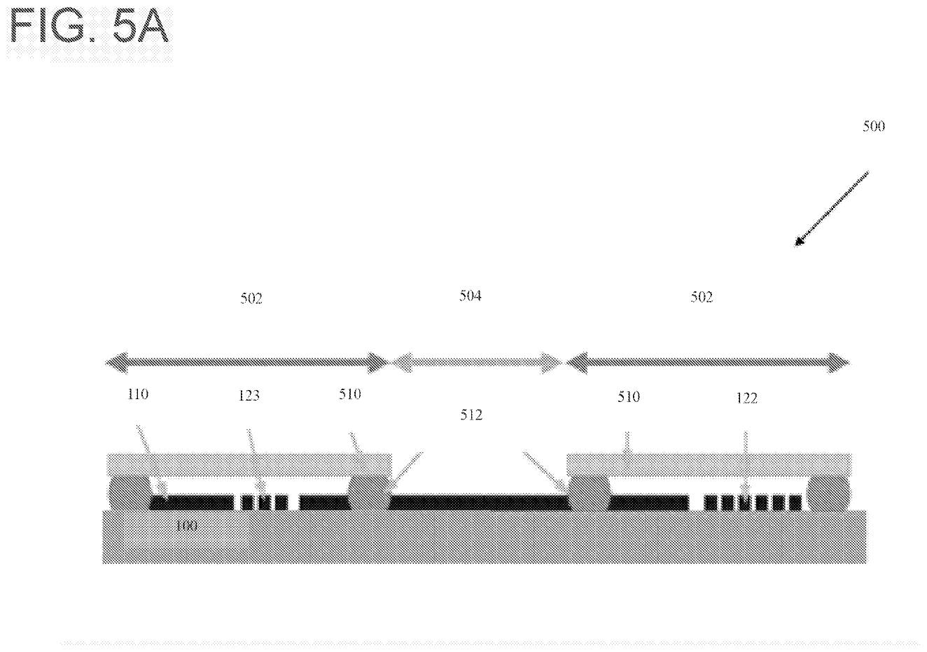

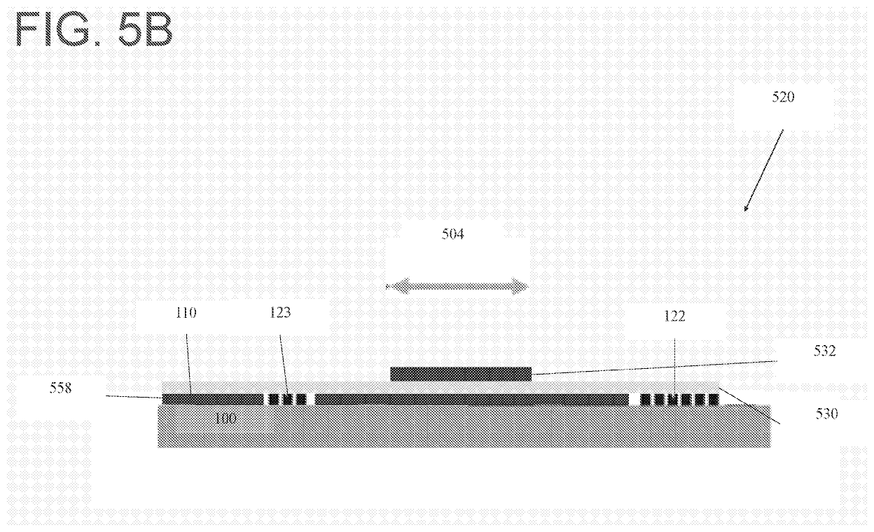

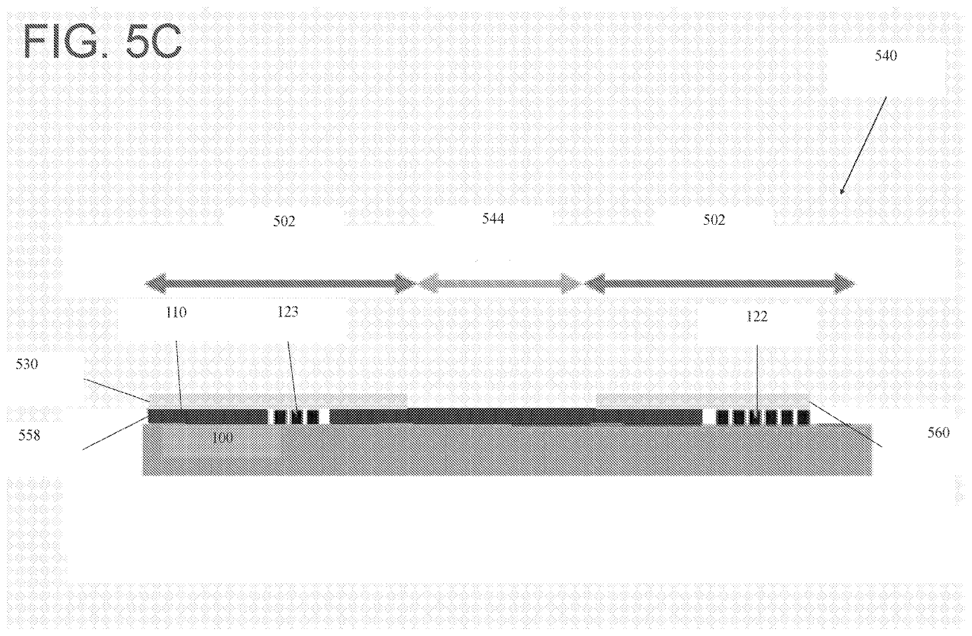

Referring now to FIG. 5A, an exemplary schematic of a fabricated wall 500 for a SAW biosensor is presented. To ensure that the IDTs and reflectors, which drive the SAW biosensor, may be protected from the fluid flow of saline and the biological sample, a fabricated wall concept may be adopted to eliminate the need for a gasket. A leaking fluid wall may attenuate the SAW signal conveying the radiofrequency wave into the crystal via the metal contact pads and IDTs leading to signal loss, affecting the functioning of the sensor. In one embodiment of the present disclosure, a fabricated wall concept may be adopted where the SAW biosensor 100 has been identified to have open sensing areas 504 and liquid-proof protecting areas 502. Open sensing areas 504 may be identified on the sensor via fiducials. In the liquid-proof protecting areas 502, regions of contacts pads 110, regions of IDTs 123 and regions of reflectors 122 are isolated from the fluid flow via lid silicon glass 510 adhered on to the SAW biosensor 100 via seal-proof silicon rubber wall 512. Alternatively, liquid-proof protection may be achieved by depositing a layer of polymethyl methacrylate (PMMA) or silicon dioxide on the SAW sensor.

FIG. 5B depicts a side view 520 where a layer of PMMA, silane or silicon dioxide 530 is overlayed on top of the metal structures 538 of the SAW biosensor 100. The layer of PMMA, silane, or silicon dioxide 530 isolates the entire SAW sensor surface from the fluid flow, including the regions of contacts pads 110, regions of IDTs 123 and regions of reflectors 122. An additional biocompatible metal layer 532, such as gold, can be deposited on top of the layer of PMMA, silane, or silicon dioxide 530 in the open sensing areas 504 for the immobilization of capture agents to the SAW sensor.

FIG. 5C depicts another such embodiment, where PMMA, silane, or silicon dioxide 530 is overlayed on top of the metal structures 538 in the regions of liquid-proof protecting areas 502 of the SAW biosensor 100. The layer of PMMA or silicon dioxide 560 isolates the regions of liquid-proof protecting areas 502 from the fluid flow, including the regions of contacts pads 110, regions of IDTs 123 and regions of reflectors 122.

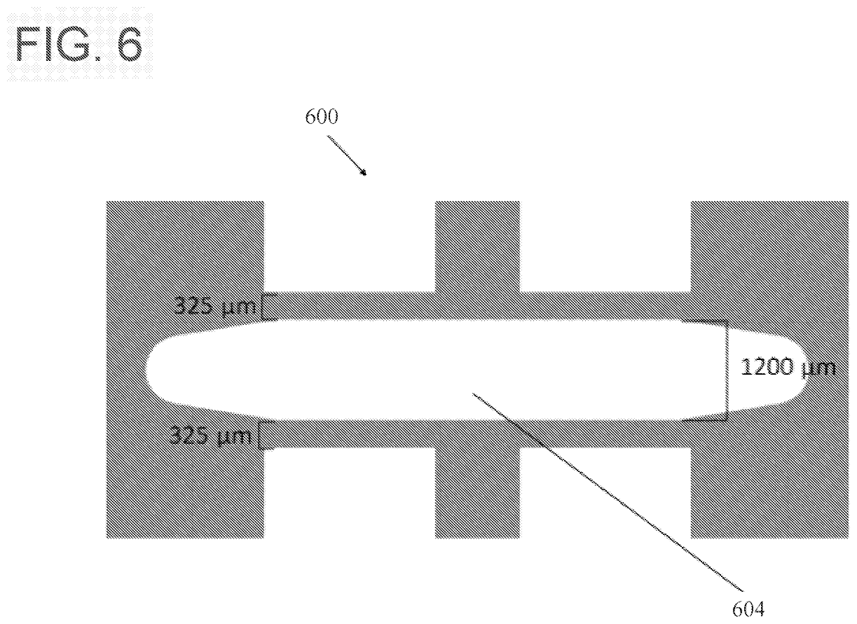

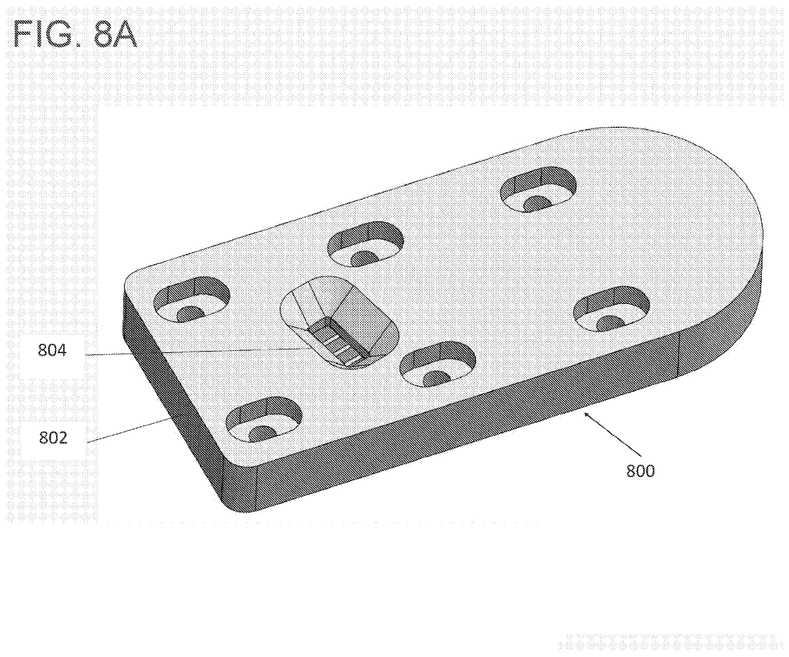

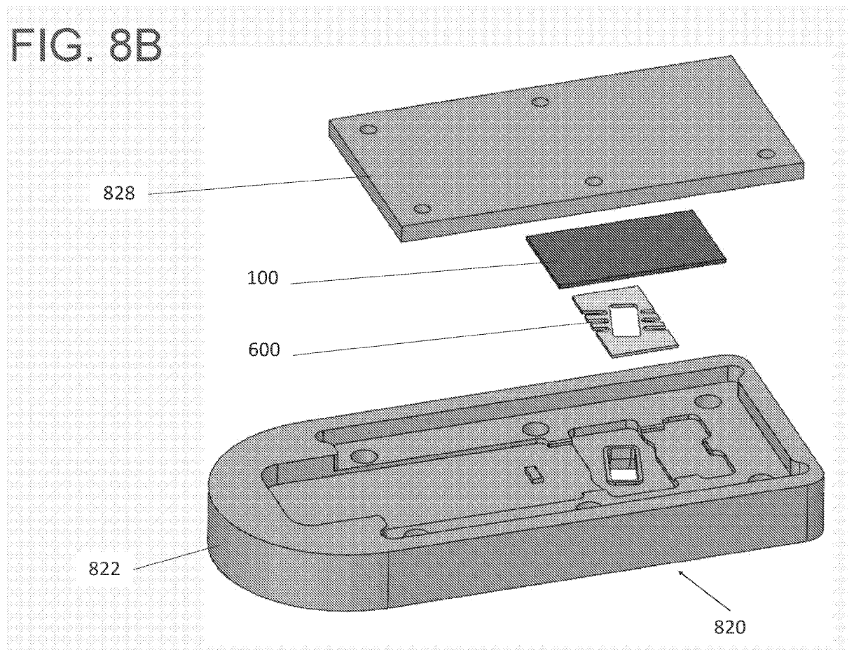

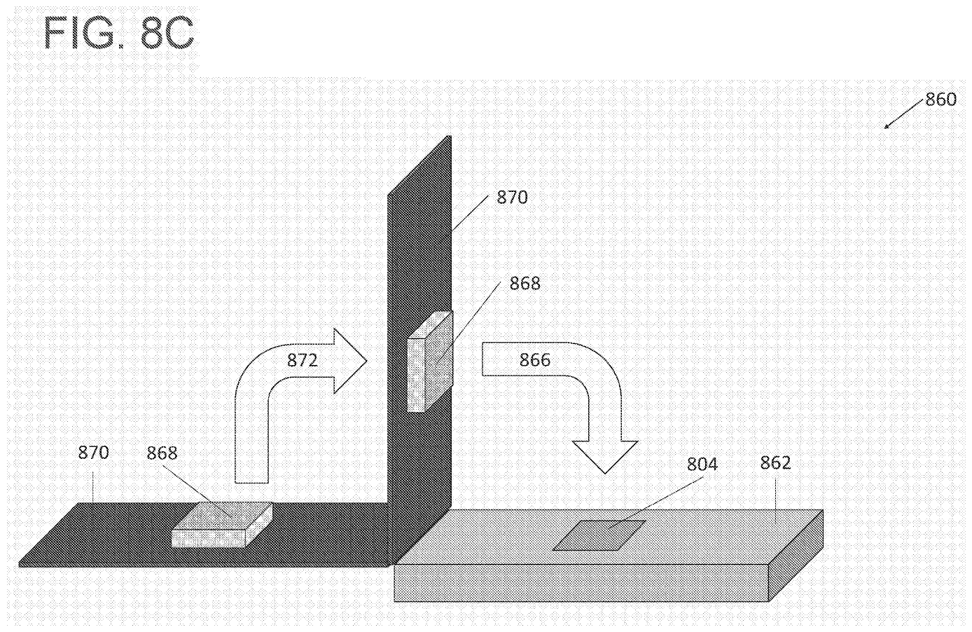

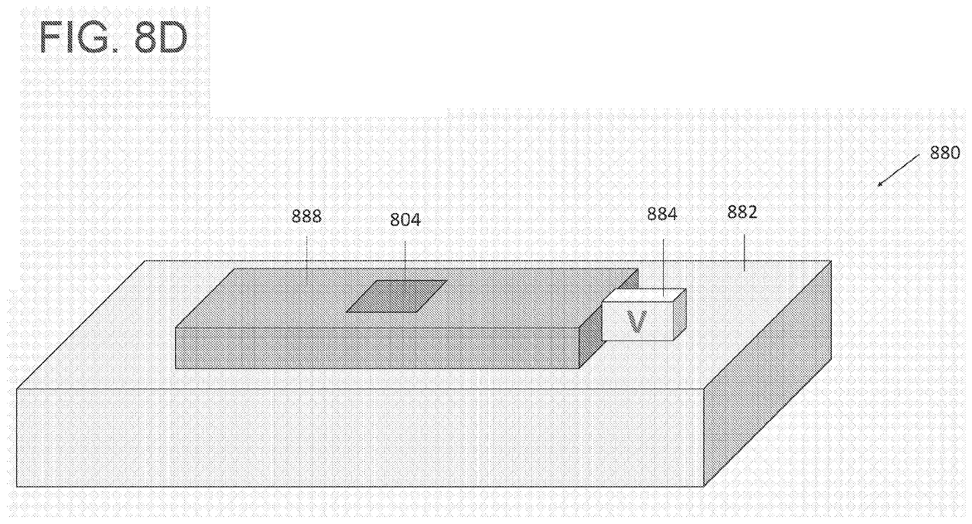

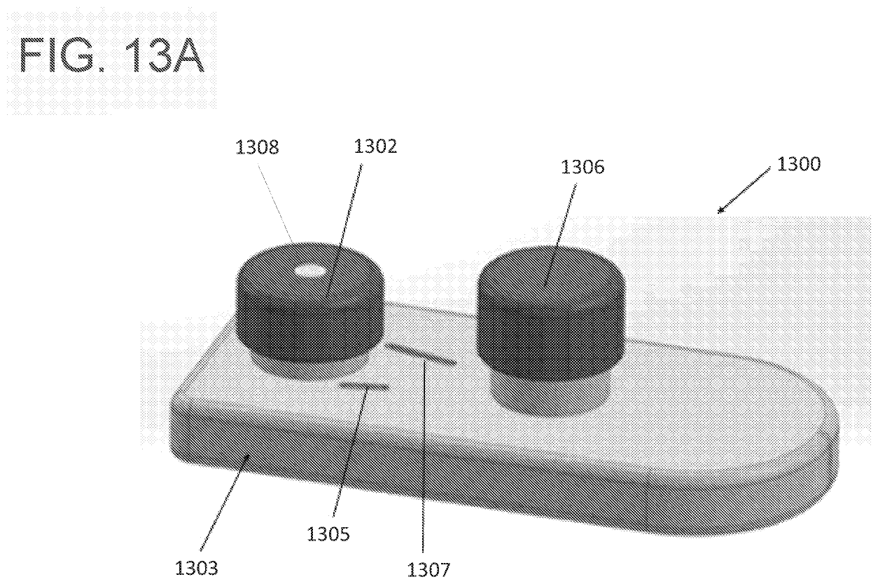

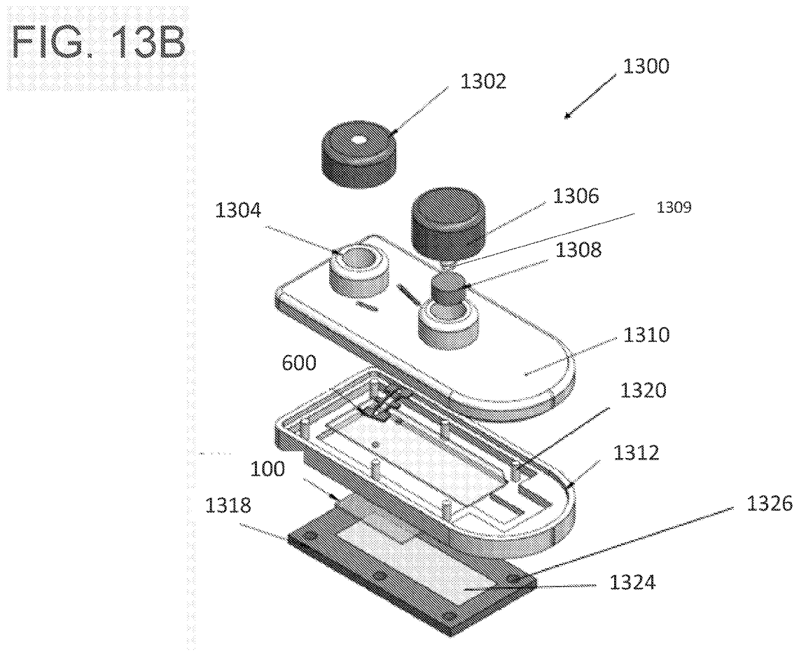

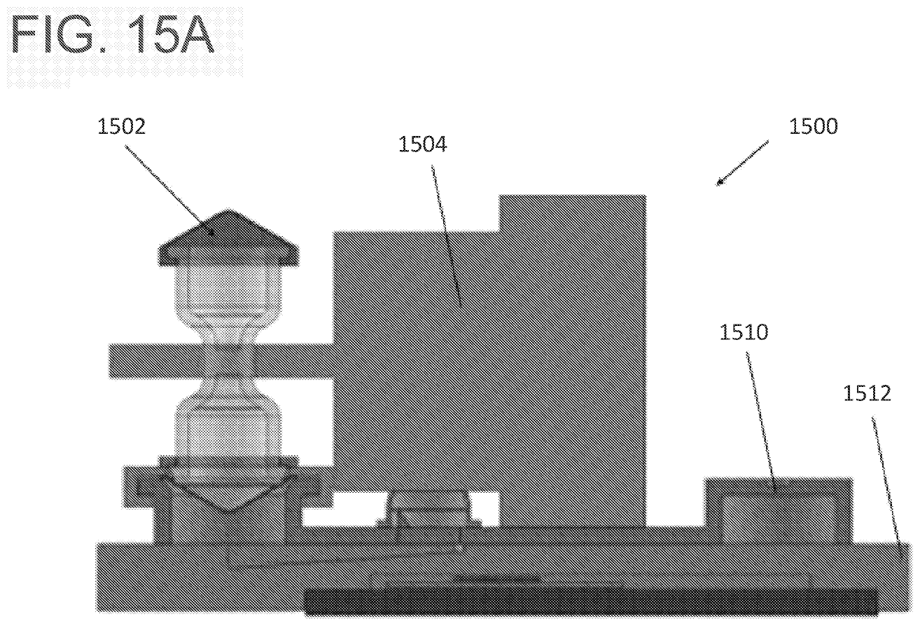

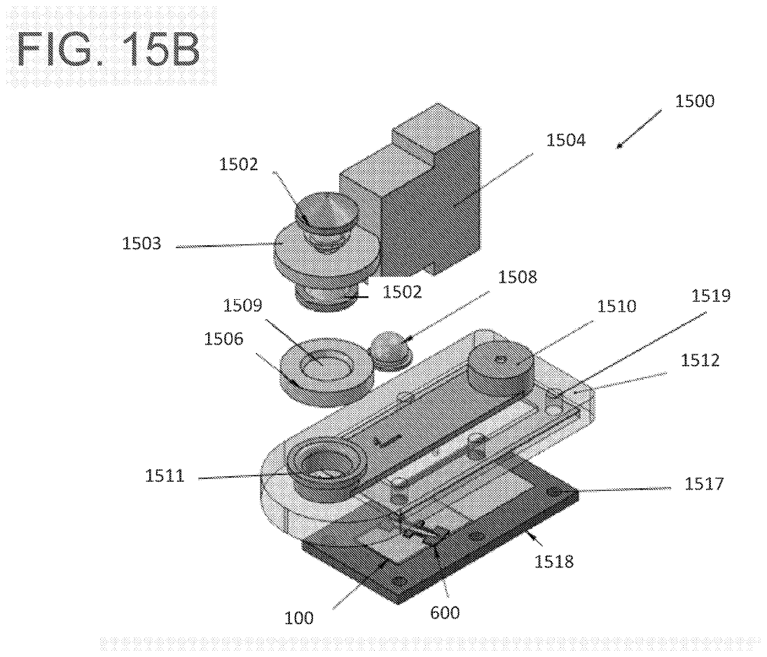

Referring now to FIG. 6, an exemplary diagram of a polydimethylsiloxane (PDMS) or some such polymer gasket 600 is presented. To further isolate fluid flow from the sensitive electrical components, the system may include a polymer gasket 600 to prevent the SAW biosensor from directly interacting with the fluid flow. The polymer gasket 600 comprises a polymer fluidic channel 604 created by the gasket to allow the biological sample to flow through. In some embodiments, as in the case of FIG. 6, the gasket may be made of PDMS or other low durometer polymer material. Disposable cartridge systems in FIGS. 8A-B, FIG. 13B, and FIG. 15B may incorporate this polymer gasket.

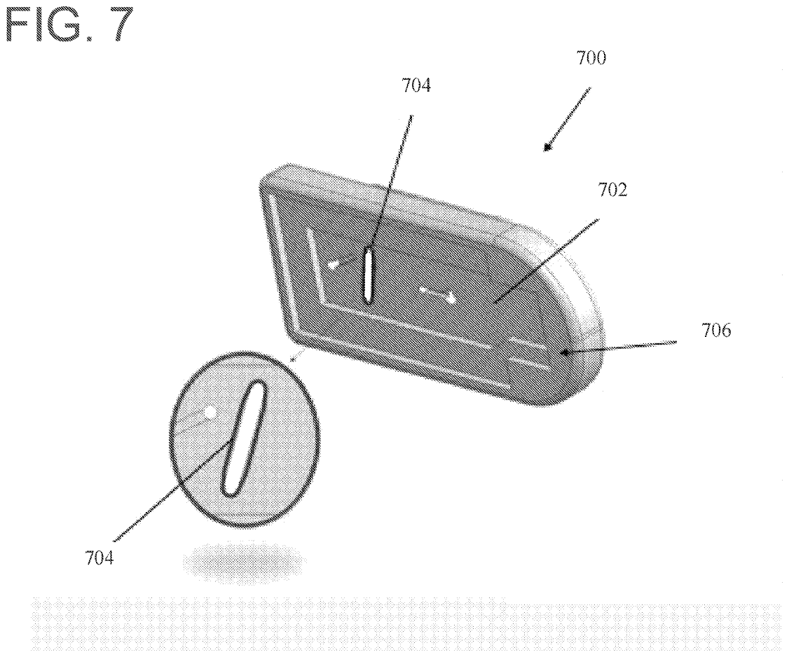

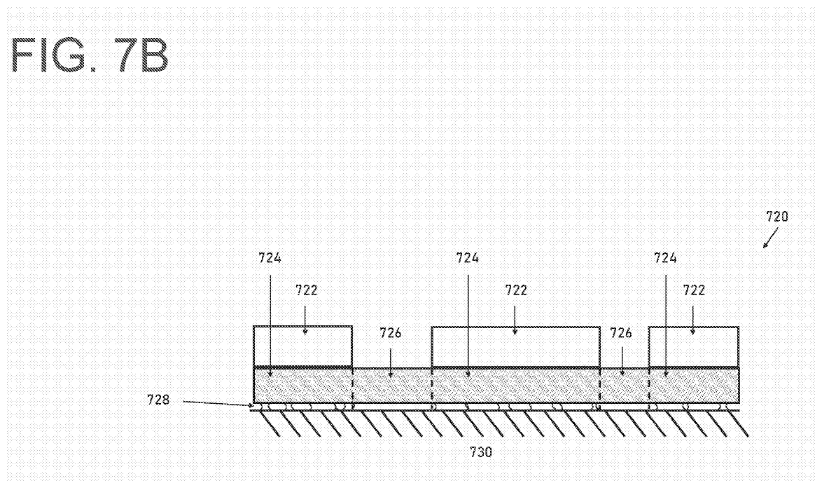

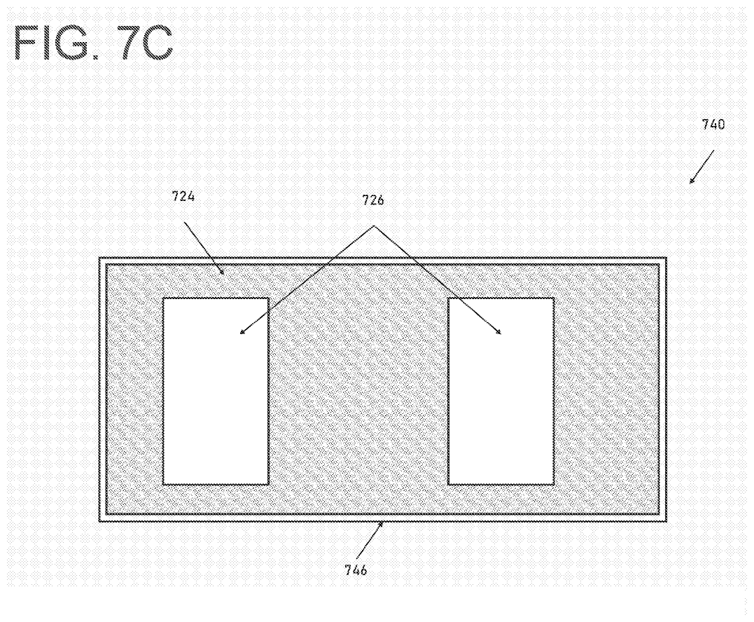

Referring now to FIG. 7A, an exemplary SAW biosensor system 700 with an enclosure comprising overmolded thermoplastic elastomers (TPE) is presented. The SAW biosensor system 700 may include an overmolded TPE gasket 704 on a top surface 702 of a cassette component 706. The system may be completely enclosed using walls of silicone or overmolded thermoplastic elastomers (TPE) which are precisely tooled to the dimensions of the sensor, allowing for the characteristics needed for a closed or open well. Such an enclosure would work for acoustic sensors using other types of acoustic waves, such as Rayleigh, shear horizontal SAW with or without an energy trapping layer, transmission or reflective delay line modes, and with bulk acoustic waves. Any type of acoustic wave traversing a piezoelectric crystal could be used in such an enclosure. All electronic components are protected, and the flow cell ties perfectly to the larger fluidic channel.

FIG. 7B depicts the side view of a felt seal 720 as an alternative to the overmolded TPE and PDMS gasket used provide protection from fluid for the SAW IDT and reflector elements. Typically, felts absorb fluids. This is true regardless of the material from which the felt is made because the high surface area of the intertwined small felt fibers interacts with the surface tension of almost any fluid to quickly absorb that fluid into the felt. But this method uses fluid repellent coatings, such as siloxane or perfluorobutanesulfonic acid (PFBS), to apply a very thin water-repellent coating to the patterned felt. The treated felt 724 is then pressed onto the surface of the piezoelectric surface 730 with some moderate pressure. Felt fluidic channels 726 cut into the felt 724 then keep the water in place without allowing the water to migrate from its intended holding spaces or flow channels. The fibers 728 of the felt extend above and below the felt by fractions of a millimeter, and each fiber is hydrophobic, preventing water from leaking above or below the flat felt 724 piece.

The other feature of this felt seal 720 is that the flexibility of the individual fibers 728 of the felt 724 that are touching the biosensor surface are not stiff enough to couple energy from the SAW. While the SAW is typically in the frequency range of tens to hundreds of megacycles per second (megahertz, MHz), the maximum vibration frequency of these fibers 728 is typically measured in tens of kilocycles per second (kilohertz, kHz), several orders of magnitude lower in frequency. Thus, even when the felt 724 is put under significant pressure on the top of the SAW biosensor, no mechanical energy is lost as the MHz mechanical waves propagate across the surface or in the bulk of the device. As these acoustic oscillations are the key to many different methods of chemical and biological sensing, the ability of this invention to hold the water in place without dampening or otherwise disturbing the acoustic waves is an important technological innovation in sensing devices.

The felt 724 pieces are placed in alignment on top of the SAW biosensor and pressed into place either with tape over the felt 724 or by being pressed by a stiff pressing item 722 such as a plastic cover that shares the 2D channel geometry instantiated by the felt. This larger assembly which contains the felt 724 is then ready for addition of liquids into the fluidic channels 726. While the felt 724 is generally used in planar configurations, the flexibility of the felt allows it to be used in cylindrical fluidic applications as well, where the felt flexibility may allow for good sealing over curved surfaces.

The density and fiber diameter and other parameters of the felt 724 are chosen to reduce mechanical coupling in the frequencies of interest and also to enable good sealing. Thickness ranges of felt range from 0.1 mm to 5 mm thick, and felt fiber 728 diameters range from 10 microns to 0.5 mm.

Alternatively, materials such as cellulose and nitrocellulose papers can also be used for this purpose after hydrophobic coatings if the coupling of the cellulose fibers is at a low enough frequency and the paper surface is rough enough. Very flat paper (with surface roughness less than +/−5 microns) typically will allow water to seep past the smooth paper/surface interface. The paper must have roughness larger than +/−10 microns on its surface to work. Multiple other materials such as nylon, polytetrafluoroethylene (PTFE), polyester, Kapton (polyamide) and wool can also be used as the felt material.

Referring now to FIG. 7C, a top perspective view of an exemplary design of the felt seal 740 with felt fluidic channels 726 cut into the treated felt 724 applied to the SAW biosensor surface 746 is presented. The stiff pressing item is not included for visual clarity.

FIGS. 8A and 8B present perspective and exploded views of an exemplary embodiment of a disposable open well cartridge system 800 comprising a SAW biosensor.

FIG. 8A shows an exemplary embodiment of the disposable open well cartridge system 800 which includes a cassette 802 and open well 804. FIG. 8B shows an exploded view of a disposable open well cartridge system 820 wherein a cassette body 822 and a cassette bottom 828 are secured together to hold the SAW biosensor 826. The disposable open well cartridge system may be integrated with a connection assembly of RF and pogo pin connectors similar to the embodiment shown in FIG. 4 to interface with SAW biosensor 100. The disposable cartridge system may also include a polymer gasket 600 to separate the biological sample from coming in contact with the SAW biosensor 100. Polymer gasket 600 integrates with the cassette body 822 to form the open well 804, which is capable of handling a variety of bodily fluid and reagents. If necessary, the disposable open well cartridge system may also include an absorbent wicking pad (now shown). Following calibration, the biological sample is simply added directly to the open well 804 and may remain there for the duration of the test. The SAW biosensor 100 is in direct communication with the connection assembly which processes the output response of the SAW biosensor 100 to the biological sample. The disposable open well cartridge system 800 may be operatively placed in a reader so that an output of the disposable open well cartridge system may be received by the reader. The output of the disposable cartridge system 800 may include a measurement or indication of SARS-COV-2 virus being present in the biological sample, as an example and may consist of any number of biomarkers or cells.

FIG. 8C shows an exemplary embodiment 860 of an open well cartridge flow cell 862 attached to a wicking apparatus 870 to absorb any fluids which need to be washed out for repeat fluid allocation. Certain testing procedures that require the addition of two fluids to the open well 804 may necessitate a washout step to remove fluid from the first addition. This can be realized by having a wicking apparatus 870 with an absorbent wicking pad 868. For the washout step, the user lifts the wicking apparatus 870 as indicated by arrows 872 and 866 to set the wicking apparatus 870 in contact with the open well 804. The absorbent wicking pad 868 then uptakes the fluid from the open well 804. The user then lifts the wicking apparatus 870 to its initial state. Upon completion, the open well 804 is ready for repeat fluid allocation.

FIG. 8D presents the use of a vibration module which can mix the fluid in the open well cartridge flow cell 880. The vibration module 884 is mounted next to the cartridge interface 882 that is part of the reusable reader. The vibration module 884 can mix the fluid in the open well cartridge flow cell 888. Power and vibration frequency of the vibration module 884 are regulated by the reusable reader. The generated vibrations cause the fluid in the open well 804 to mix, which may be necessary to promote the reaction of the analytes in the fluid with the functionalized SAW biosensor surface.

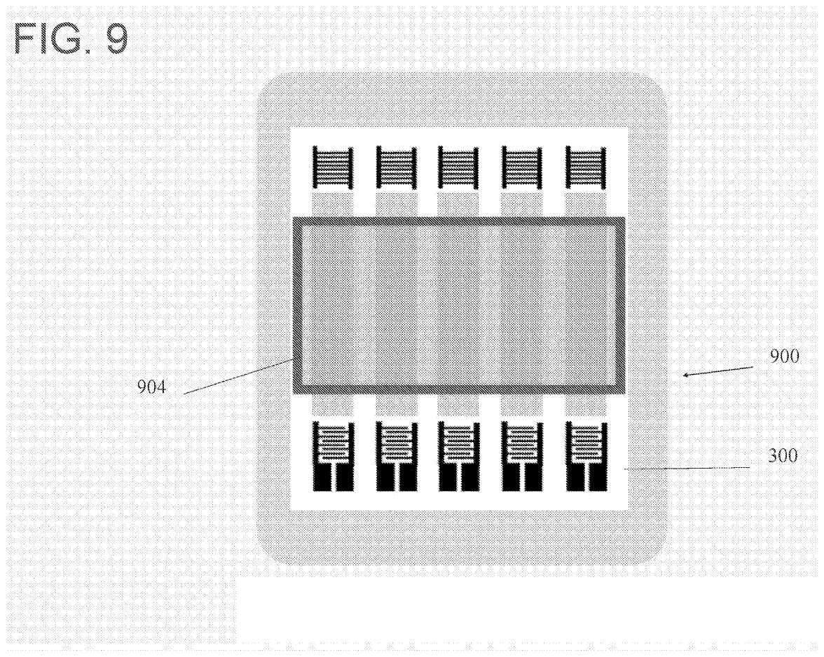

Referring now to FIG. 9, a perspective view of a multiplexed SAW biosensor 300 and multiplexed cassette bottom 900 with multiple waveguides on a single sensor and an adapted flow cell 904 to spread over the entire multiplexed system is presented. This concept allows for the same fluid to simultaneously interact with the multiple waveguides on the multiplexed SAW biosensor 300.

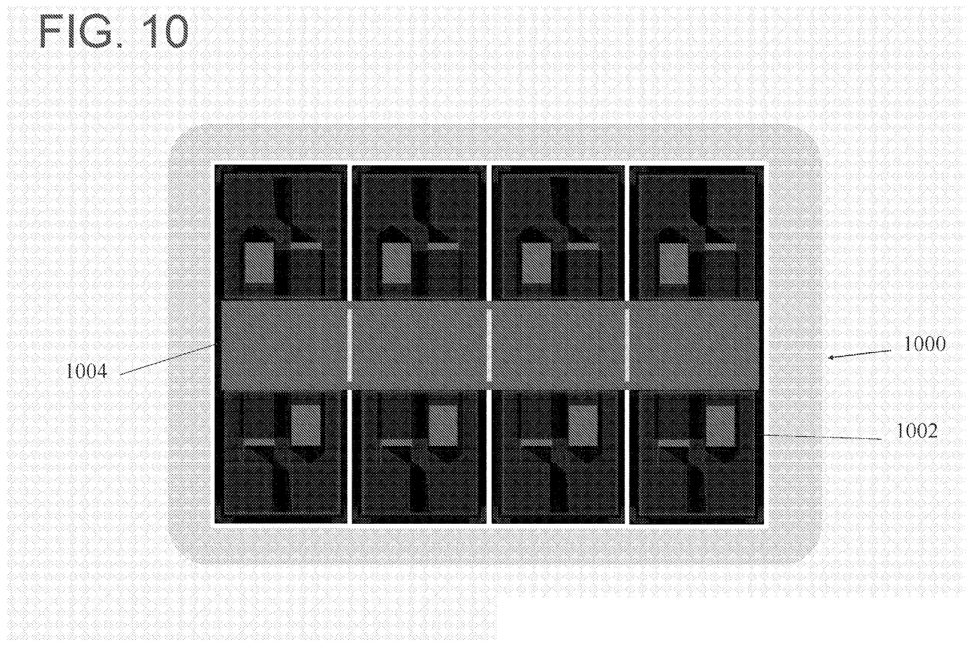

FIG. 10 presents a perspective view of SAW sensors multiplexed with multiple uniplex sensors 1002 in an array, multiple uniplex cassette bottom 1000, and an adapted multiple uniplex flow cell 1004 over the entire multiplexed system. This concept allows for the same fluid to simultaneously interact with the multiple uniplexed sensors 1002.

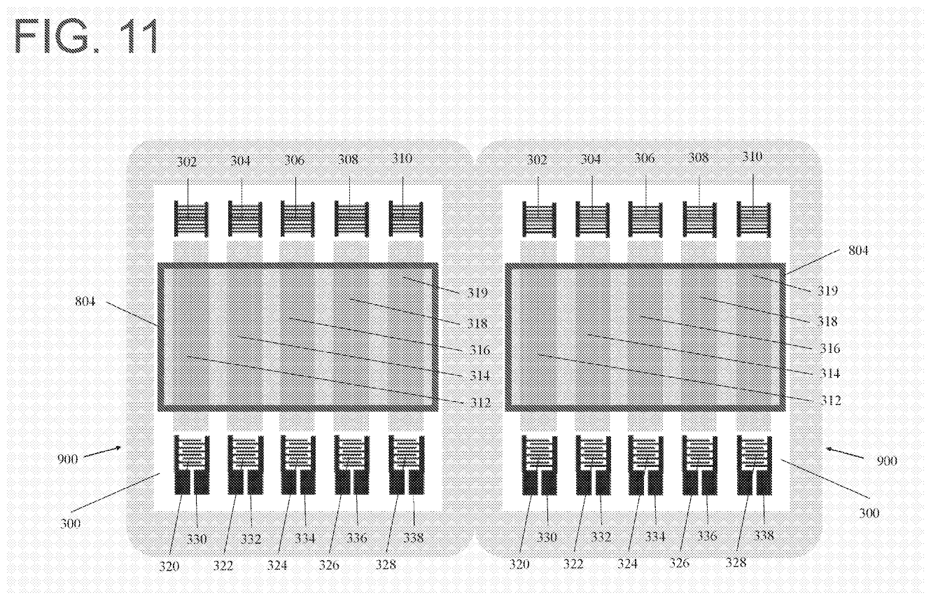

FIG. 11 presents a perspective view of two multiplexed SAW biosensors 300 with each having its own open well 804 and cassette bottom 900. The two multiplex sensors are combined into one unit for a multi-well cartridge. According to an aspect of the present disclosure, an input electrical signal from the reader is traversed through IDTs, a waveguide, and then reflected back via reflectors to the IDTs, where it is reconverted into an electrical signal. Changes in phase and amplitude of the electrical signal are measured by the reader. The phase change data and amplitude change data may then be transformed by appropriate signal algorithms for detecting selected target components of a sample. According to an aspect of the disclosure, multiple IDTs can be configured in a series or in an electrical parallel arrangement.

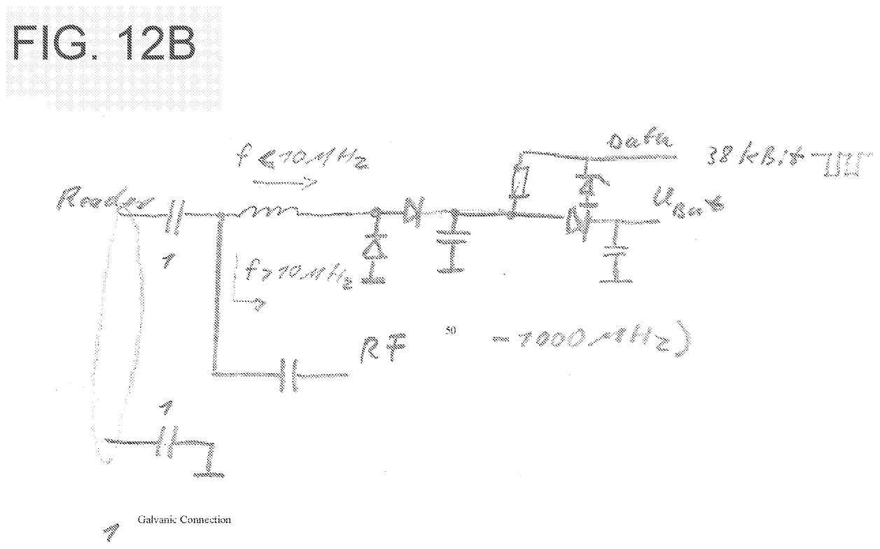

FIG. 12A demonstrates a circuit of the electrical parallel arrangement, as the delay line connects the reader and a cartridge. In certain embodiments utilizing a multiplex approach, multiple waveguides on a single sensor (as exemplified in FIG. 9) or multiple uniplex SAW sensors (as exemplified in FIG. 10) are housed together within a cartridge, along with a switch which selects a waveguide or sensor, respectively, to interrogate.

FIG. 12B demonstrates that upon stimulation, the switch routes an RF electrical signal in the range of 50 to 1000 MHz to the sensor currently being interrogated. To provide the switch with energy and the control signal, the galvanic connection enables the transfer of phase change data and amplitude change data associated with the energy transfer, across the circuit. Then, the system uses a 1 MHz carrier on/off control signal for the switch to enable the phase change data and amplitude change data associated with the energy transfer. Additionally, a third signal is rectified and used as energy supply to the switch and to the microcontroller, decoding the on/off keying to control the switch.

FIGS. 13A and 13B present perspective and exploded views of an exemplary embodiment of disposable cartridge system 1300 comprising a SAW biosensor for the detection of infectious diseases. The exemplary embodiment of the disposable cartridge system 1300 may include a disposable cartridge cassette 1303 including a cassette body 1313 and a disposable cartridge cassette bottom 1312 secured together for holding the sample. The cassette body 1313 and the disposable cartridge cassette bottom 1312 may be secured to each other via vertical posts 1320, for example. The disposable cartridge system 1300 also includes a SAW biosensor 100 attached to a printed circuit board 1318. The printed circuit board 1318 is then attached to the disposable cartridge cassette bottom 1312. The printed circuit board 1318 may be secured to the disposable cartridge cassette bottom 1312 via screws (not shown in the figure) through the screw holes 1326 along the perimeter of the printed circuit board 1318, for example. The disposable cartridge system also includes a polymer gasket 600 to separate the biological sample from coming in contact with the SAW biosensor 100 and the printed circuit board 1318. The printed circuit board 1318 includes a connection region 1324 comprising printed circuit board contacts (not shown).

According to an aspect of the present disclosure, the cassette 1303 includes outlines of internal fluidic pathway 1 1305, and fluidic pathway 2 1307. A biological sample may be placed in a sample well 1304 and secured with a sample cap 1302 on the disposable cartridge cassette top 1310. In an illustrative embodiment, the sample cap 1302 includes an air vent 1308. The disposable cartridge system 1300 may be secured onto a reader (not shown) for calibration.

Following calibration, a saline cap 1306 comprising a spring 1309 is pushed down on a saline-saturated compression pad 1308 on the disposable cartridge cassette top 1310. The rebounding spring force of the spring 1309 in the saline cap 1306 may be designed to allow the saline-saturated compression pad 1308 to decompress and pull the saline back into the saline-saturated compression pad 1308 at a controlled rate. The saline cap 1306 is then pushed down against the spring 1309 causing the saline in the saline-saturated compression pad 1308 to flow through a channel over the SAW biosensor 100 to the sample well 1304.

The SAW biosensor 100 is in direct communication with the printed circuit board 1318 which processes the output response of the SAW biosensor 100 to the biological sample. The disposable cartridge system 1300 may be operatively placed in a reader so that an output of the disposable cartridge system may be received by the reader. The output of the disposable cartridge system 1300 may include a measurement or indication of SARS-COV-2 virus being present in the biological sample, for example.

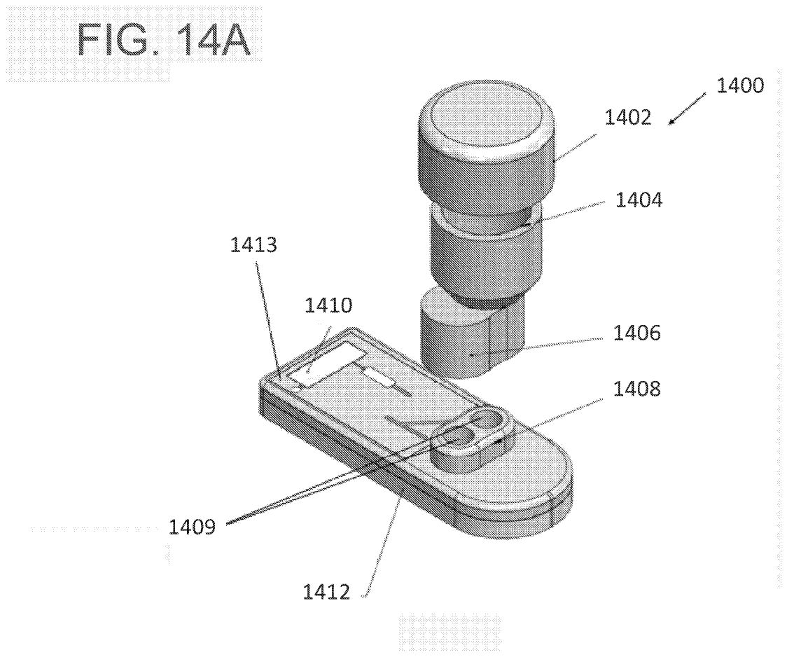

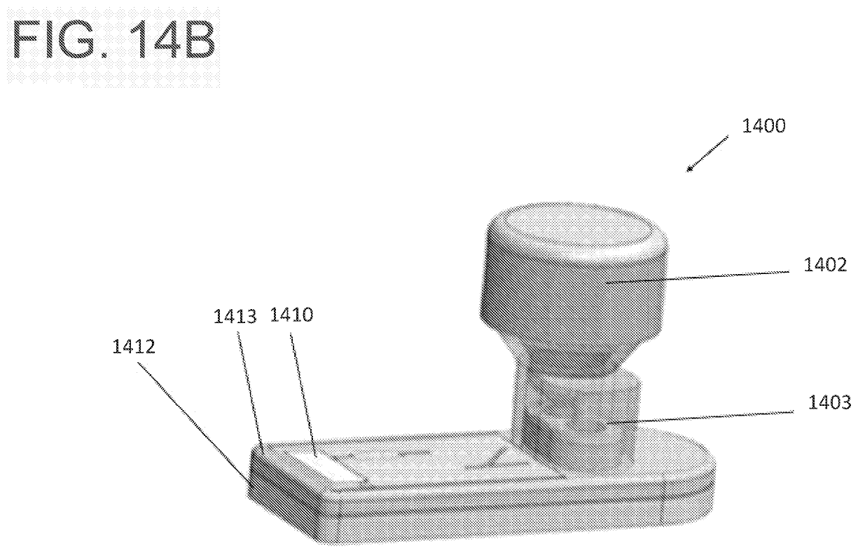

FIGS. 14A and 14B present a perspective and exploded view of another illustrative embodiment of second disposable cartridge system 1400 comprising a SAW biosensor for the detection of infectious diseases according to aspects of the present disclosure. The second disposable cartridge system 1400 comprises a second disposable cartridge cassette body 1412 and a cassette top cover 1413 secured together and comprising a SAW biosensor, a printed circuit board, and a gasket to prevent the biological sample from directly being contacted with the SAW biosensor. According to an aspect of the present disclosure, a biological sample may be placed in a second disposable cartridge sample well 1404 and secured with a second disposable cartridge sample cap 1402.

The second disposable cartridge cassette body 1412 may be placed on a reader (not shown) for calibration. Saline pinch valves (not shown) in the second disposable cartridge cassette body 1412 may be activated when the second disposable cartridge cassette body 1412 is placed on a reader for calibration.

The second disposable cartridge sample well 1404 containing the sample secured with a second disposable cartridge sample cap 1402 is attached to a saline well 1406 to form a sample-saline complex 1403 and loaded onto the cassette top cover 1413 via a docking location 1408. The docking location 1408 comprises at least two loading wells 1409. In one aspect of this exemplary embodiment, the second disposable cartridge sample well 1404 and the saline well 1406 comprise foils securing the respective liquids in their respective well. When the second disposable cartridge sample well 1404 and the saline well 1406 are attached to the loading wells 1409, the foils are pierced and the saline pinch valve is opened, exposing saline and the sample to channels (not shown) in the second disposable cartridge cassette body 1412.

According to an aspect of the present disclosure, the saline pinch valves are designed to be opened first to allow saline to flow over the SAW biosensor and contact the absorbent wicking pad 1410 on the second disposable cartridge cassette body 1412. In an illustrative embodiment, the absorbent wicking pad 1410 pulls the saline at a rate of 5ul/min. Proceeding the opening the saline pinch valve for 5 minutes, the saline pinch valve is closed and the sample is allowed to be exposed to the SAW biosensor and then contact the absorbent wicking pad 1410. The SAW biosensor may be in direct communication with the printed circuit board which in turn processes the output of the SAW biosensor due to the biological sample and an output of measurement (e.g., presence of an infectious virus in the biological sample) may be noted by the reader when the second disposable cartridge system 1400 is placed in the reader.

FIGS. 15A and 15B present a perspective and exploded view of a further exemplary embodiment of third disposable cartridge system 1500 comprising a SAW biosensor for the detection of infectious diseases, chemicals, proteins, nucleotides and cellular elements. The exemplary embodiment of the disposable cartridge system 1500 comprises a third disposable cartridge cassette body 1515 further comprising a saline blister pack 1508, SAW biosensor 100 attached to a printed circuit board 1518, and a polymer gasket 600 to separate the biological sample from coming in contact with the SAW biosensor 100 and the printed circuit board 1518. The printed circuit board 1518 is secured onto the third disposable cartridge cassette body 1512 via vertical posts 1519 which fit on the post voids 1517 on the perimeter of the printed circuit board 1518. The biological sample may be placed in a sample well 1511 and secured with a flexible sample cap 1506 on the third disposable cartridge cassette body 1515. The disposable cartridge system 1500 may be secured onto a reader (not shown) for calibration. Following calibration, a reusable flexible hourglass with grains 1502 held by a holding platform 1503 of a timer holder 1504 may be placed on the third disposable cartridge cassette body 1515, leading to opening the saline blister pack 1508. As grains in the reusable flexible hourglass with grains 1502 slowly transfer to the bottom of the hourglass and compress the indented region 1509 of a flexible sample cap 1506, the biological sample may be forced into the channel (not shown in the figures) in the third disposable cartridge cassette body 1512, and allowed to interact with the SAW biosensor 100 Eventually the saline from the saline blister pack 1508 and the biological sample are displaced to the waste well with an air vent 1510. The SAW biosensor 100 may be in direct communication with the printed circuit board 1518 which in turn processes the output of the SAW biosensor 100 due to the biological sample and an output of measurement (e.g., presence of a virus in the biological sample) may be noted in the reader when the disposable cartridge system 1500 is placed in the reader. Also included could be a vibration module to shake the liquid contained in the flow cell.

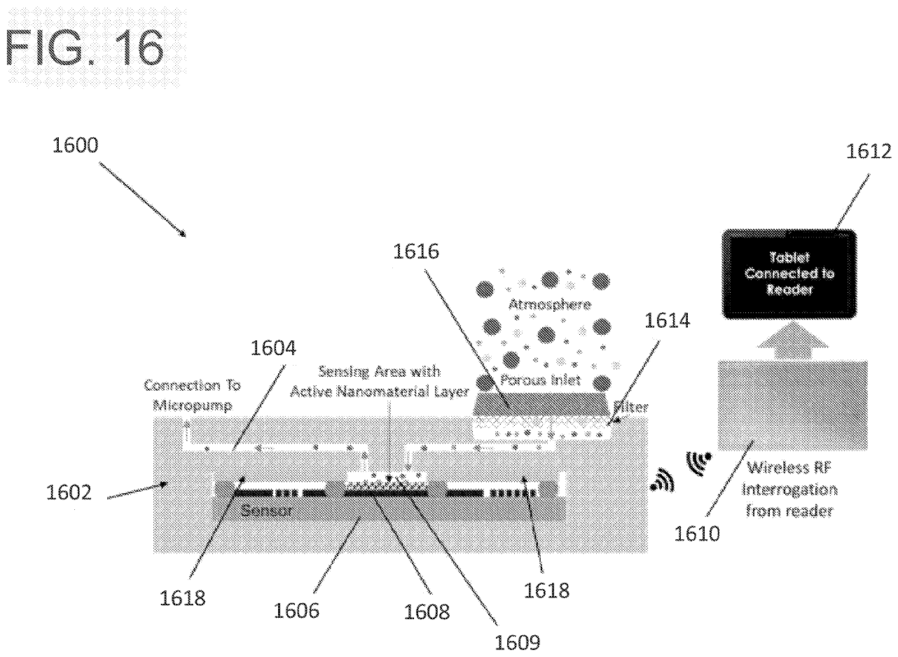

Referring now to FIG. 16, a perspective view of an exemplary embodiment of a SAW biosensor cartridge system 1600 adapted for collection and detection of gaseous species from the atmosphere is presented. The SAW biosensor cartridge system 1600 includes a gaseous species cassette 1602 with a gaseous species sensor 1606 which may include a liquid-proof sealing 1618, only revealing a sensing area 1609 coated with an active nanomaterial layer 1608. The gaseous species cassette 1602 includes a porous inlet 1616 with a filter 1614 for gaseous species input from the atmosphere. The gaseous species input may travel through a gaseous species channel 1604 connected to a micropump (not shown in the figure) allowing the gaseous species input to flow through the gaseous species channel 1604 for interaction with the sensing area 1609 coated with an active nanomaterial layer 1608. In one embodiment, the data from the gaseous species sensor 1606 may then be transmitted to a reader via wireless radio frequency interrogation 1610 connected to a tablet 1612.

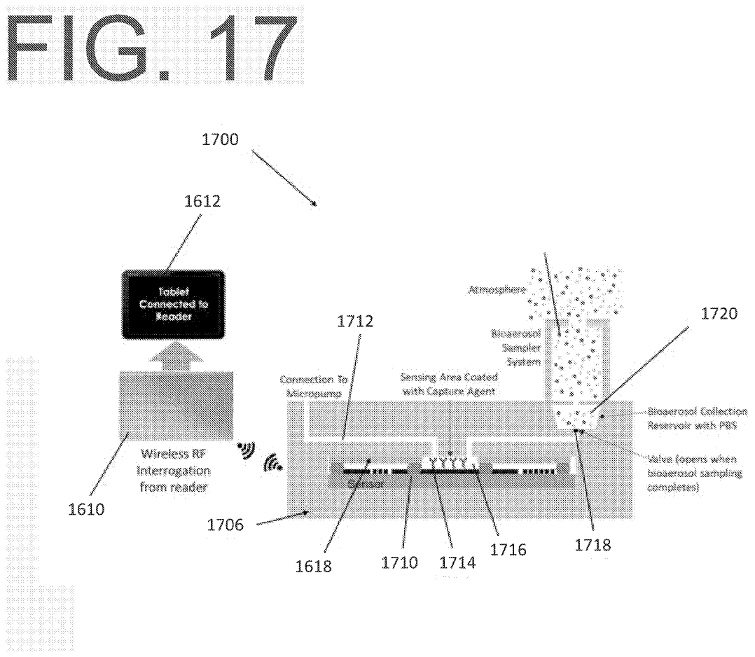

Referring now to FIG. 17, a perspective view of an exemplary embodiment of a SAW biosensor cartridge system adapted for collection and detection of bioaerosols from the atmosphere. The second SAW biosensor cartridge system 1700 includes a bioaerosol cassette 1706 with a bioaerosol sensor 1710 which may include a liquid-proof sealing 1618, only revealing a bioaerosol sensing area 1716 coated with a capture agent 1714. The bioaerosol cassette 1706 includes a bioaerosol sampler system 1722 with a bioaerosol collection reservoir 1720 for holding the bioaerosol input from the atmosphere. The bioaerosol collection reservoir 1720 is fluidly connected to a bioaerosol fluidic channel 1712 via a valve 1718. The sample bioaerosol may travel through the bioaerosol fluidic channel 1712 connected to a micropump (not shown in the figure) allowing the bioaerosol input to flow through the bioaerosol fluidic channel 1712 for interaction with the bioaerosol sensing area 1716 coated with the capture agent 1714. In one embodiment, the data from the bioaerosol sensor 1710 may then be transmitted to a reader via wireless radio frequency interrogation 1610 connected to a tablet 1612. FIG. 22 represents capture of chemical and infectious disease agents from waste water or ground water or potable water into the flow cell with or without concentration of said sample.

Aspects of the present disclosure further includes a disposable cartridge system utilizing a surface acoustic wave (SAW) biosensor, disposable PCB assembly, fluid gasket, buffer can that contains saline, and a screw cap that can be used for the detection of infectious agents. A vibration module can also be added to shake up the reaction mix.

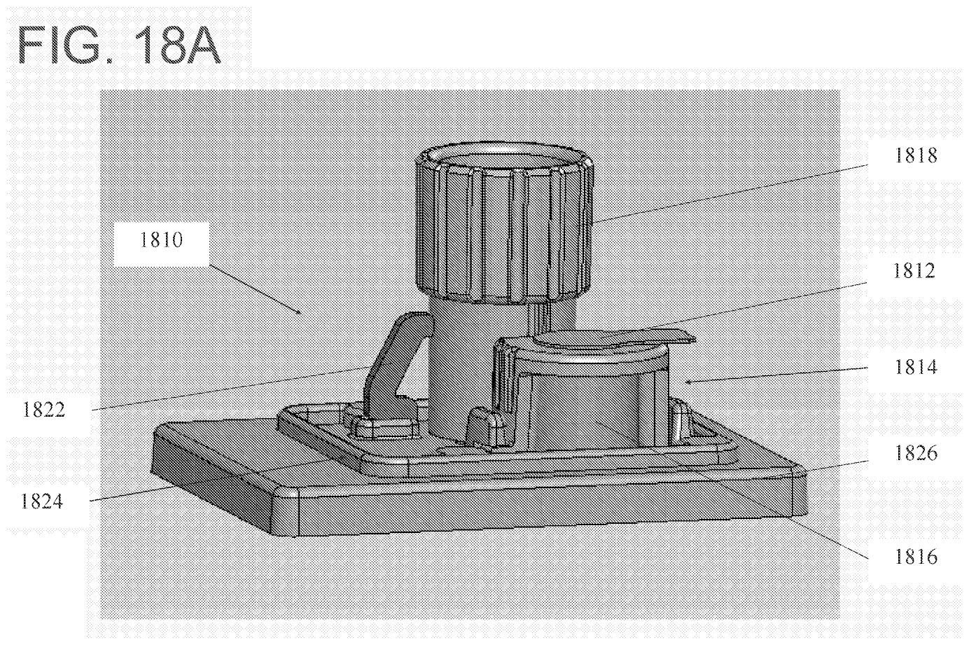

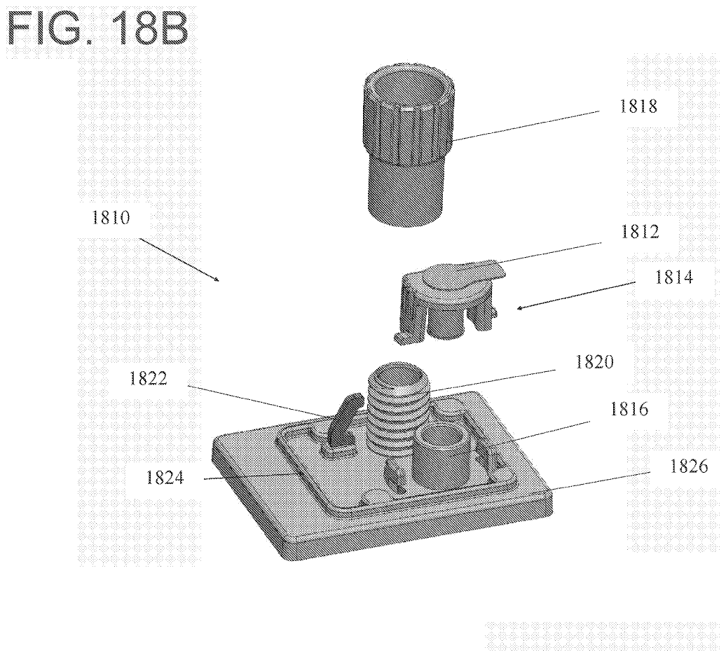

FIG. 18A shows a perspective view of the screw cap disposable cartridge 1810, and FIG. 18B presents an exploded view of the screw cap disposable cartridge 1810. According to some embodiments, screw cap disposable cartridge 1810 can be docked onto a holder and wait for calibration. As shown in FIGS. 18A and 18B, screw cap disposable cartridge 1810 includes top foil 1812 disposed over buffer can 1814, which can be removed by a user once calibration is complete to pierce a foil (not shown) at the bottom of buffer can 1814. As shown in FIG. 18B, buffer can 1814 is configured to mated with cylinder 1816 during assembly. Screw cap disposable cartridge 1810 also includes screw cap 1818 and snap arm 1822, which can be activated by a user to activate the flow of, for example, saline from the buffer can 1814 through the channel 1818 over the sensory aspect (not shown) of screw cap disposable cartridge 1810. This permits the user to add the sample (not pictured) to the buffer can 1814 and turn the screw cap 1818 again, which activates the flow of the sample from the buffer can 1814 through the screw cap channel 1820 over the sensory aspect of screw cap disposable cartridge 1810. According to the example embodiments, each of these components are located within perimeter 1824, and is disposed on base 1826.

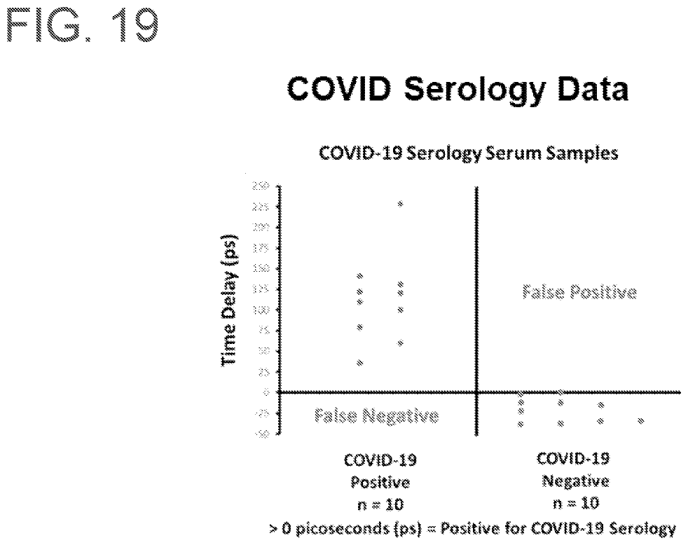

FIG. 19 presents a data table 1900 demonstrating the ability of the systems of the present disclosure to detect SARS-COV-2 serology in clinical samples. According to the illustrative example, a sensor surface was immobilized with a recombinant SARS-COV-2 spike receptor-binding domain (RBD) protein for capturing SARS-COV-2 IgG antibodies. SARS-COV-2 IgG positive (n=10) and negative (n=10) human serum samples were evaluated without any sample processing with results obtained on average in 5.5 minutes. The results from this preliminary study indicate ability of the system to detect SARS-COV-2 IgG antibodies in clinical samples with 100% sensitivity and 100% specificity. Thus, data table 1900 shows that the platform and the systems and devices of the present disclosure have the potential to be a POC method for improved detection of host generated antibodies against SARS-COV-2 and other infectious diseases.

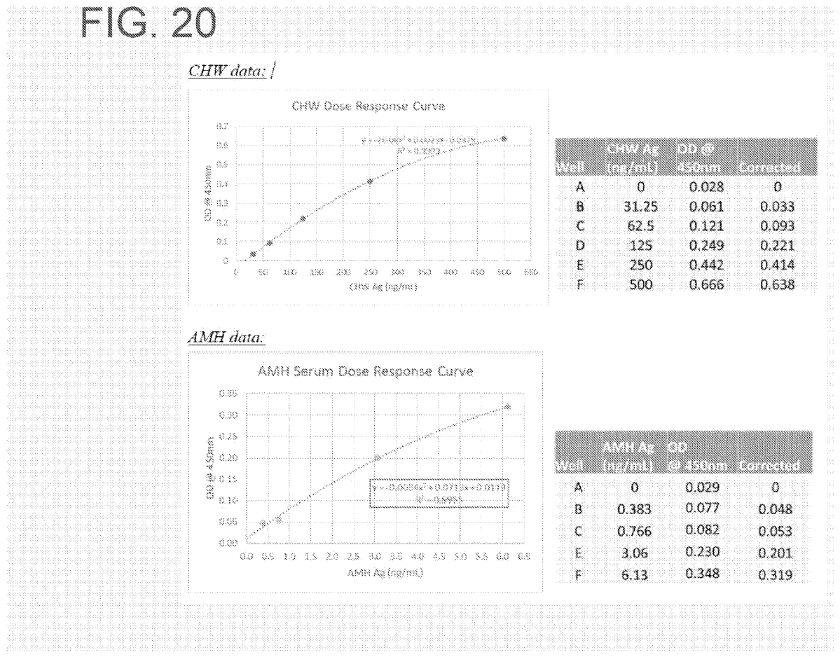

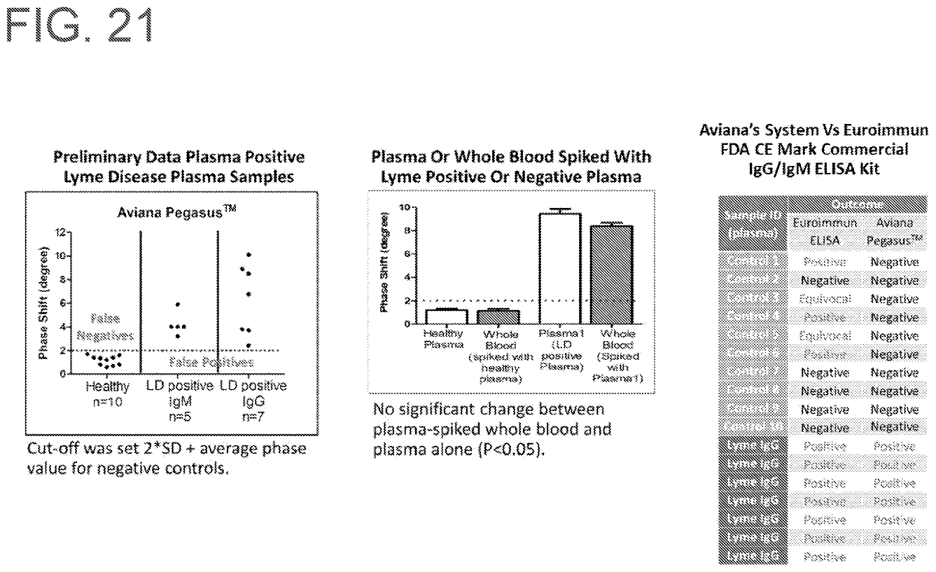

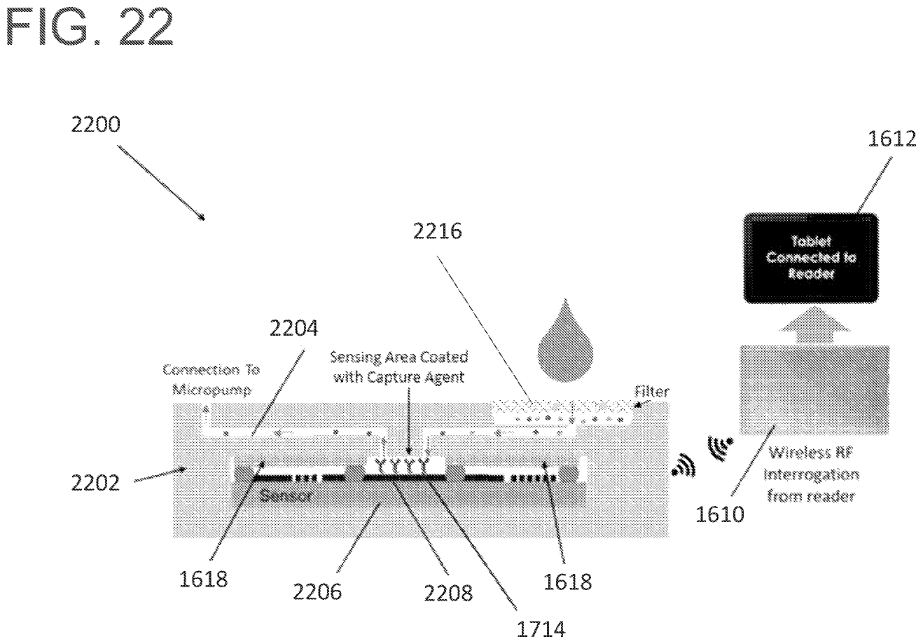

FIG. 20 presents graphs and data tables demonstrating the ability of gold coated surfaces to detect Canine Heart Worm Antigen (CHW) and canine Anti-Mullerian Hormone (AMH) via ELISA. According to the illustrative embodiment, the gold coated surfaces were immobilized with antibody-based capture agents for detecting CHW and canine AMH, respectively. The data demonstrates quantitative detection at picogram levels, which can correlate directly to sensor function.

Referring now to FIG. 21, data demonstrating the ability of the systems of the present disclosure to detect host generated antibodies against Borrelia burgdorferi (Bb) in clinical samples is presented. According to the illustrative embodiment, a sensor surface was immobilized with a recombinant antigen that consists of full-length DbpA, PepC10, C6 for capturing Bb specific IgM and IgG antibodies. Lyme Disease IgM positive (n=5), Lyme Disease IgG positive (n=7), and Lyme Disease IgM/IgG negative plasma samples were evaluated without any sample processing The results from this preliminary study indicate the ability of the system to detect Lyme Disease IgM/IgG antibodies in clinical samples with 100% sensitivity and 100% specificity. In addition, detection in whole blood was demonstrated without any sample processing. There was no significant change between plasma-spiked whole blood and plasma alone (P<0.05). The Lyme Disease assay results of the systems of the present disclosure were compared to a FDA/CE mark commercial IgM/IgG ELISA kit. The ELISA kit had 3 false positive and 3 equivocal results while the systems of the present disclosure had no false positive or false negative results. Thus, this data further demonstrates that the platform and the systems and devices of the present disclosure have the potential to be a POC method for improved detection of host generated antibodies against infectious diseases.

FIG. 22 presents a perspective view of an exemplary embodiment of a third SAW biosensor cartridge system 2200 adapted for collection and detection of biological agents, such as infectious diseases, and chemical toxins, such as PFAS, from the waste water, potable water and ground water. The third SAW biosensor cartridge system 2200 includes a waste water cassette 2202 with a waste water sensor 2206 which may include a liquid-proof sealing 1618, only revealing a waste water sensing area 2208 coated with a capture agent 1714. The waste water cassette 2202 includes an inlet with a membrane filter 2216 to remove large particulates from the water sample input. The water sample input may travel through a waste water channel 2204 connected to a micropump (not shown in the figure) allowing the water sample input to flow through the waste water channel 2204 for interaction with the waste water sensing area 2208 coated with the capture agent 1714. In one embodiment, the data from the waste water sensor 2206 may then be transmitted to a reader via wireless radio frequency interrogation 1610 connected to a tablet 1612.

There are many instances when a rapid, portable, and accurate testing platform can add critical data to diagnose, leading to diagnosis of rapidly evolving biological events including proper treatment and decrease spread of infectious agents or detect the antibody reaction to such agents. Such a system, which can trace, analyze and handle large amounts of data related to such a diagnosis, is critical for prevention, treatment, and managing future outbreaks or follow disease course, therapeutic efficacy and safety and provide critical public health data in real time basis. Other examples of such utility can include non-infectious conditions such as chemo or bio toxin threats, where remote and constant monitoring can identify and isolate a person or non-persons carrying or distributing such materials using this technology. Other examples include measure of biomarkers to detect illness or wellness and oncologic markers on cell surface or in liquid phase to detect such markers. In addition, diagnosis of veterinary and human situations (disease and wellness) that can identify and treat rapidly can make a difference such as biomarkers which can rapidly identify traumatic brain injury, stroke, or myocardial infarction. Course of disease and therapy can also be monitored using these biomarkers and our system.

Although aspects of the present disclosure and certain examples are described herein in terms of biological, waste water and ground water samples or infectious samples, it should be understood by persons having ordinary skill in the art that the aspects and various alternative embodiments of the present disclosure could be performed on or implemented to detect non-biological and/or non-infectious analytes or samples and the like, within the scope of the present disclosure.

Although various aspects of the present disclosure are described herein in terms of various exemplary embodiments, it should be understood that variations and modifications may be made to the disclosure described herein to adopt it to various usages and conditions within the scope of applicant's invention as claimed herein.

The recitation of a listing of elements in any definition of a variable herein includes definitions of that variable as any single element or combination (or sub-combination) of listed elements. The recitation of an embodiment herein includes that embodiment as any single embodiment or in combination with any other embodiments or portions thereof.

All patents and publications mentioned in this specification are herein incorporated by reference to the same extent as if each independent patent and publication was specifically and individually indicated to be incorporated by reference.

1. An integrated acoustic wave biosensor system, comprising,
a disposable cartridge component, which includes,
a cassette including:
a radiofrequency (RF) port configured to receive an RF signal;
a well for the addition of a sample in a fluid;
an integrated acoustic wave biosensor, wherein the integrated acoustic wave biosensor includes:
a piezoelectric base;
at least one metal coated channel;
a coded reflector system;
at least one sensor;
at least one set of interdigital transducers (IDTs); and
at least two contact pads;
a galvanic connection assembly coupled to the integrated biosensor; and
a sealing device configured to separate the fluid from the integrated acoustic wave biosensor;
wherein, the integrated acoustic wave biosensor is activated an RF source.

2. The integrated acoustic wave biosensor component of claim 1, wherein the sealing device is a fabricated wall.

3. The integrated acoustic wave biosensor component of claim 2, wherein the fabricated wall is comprised of a silicone rubber material adhered along a perimeter of a sensing area of the integrated acoustic wave biosensor.

4. The integrated acoustic wave biosensor component of claim 1, wherein the sealing device is a polymer gasket or a felt seal.

5. The integrated acoustic wave biosensor component of claim 1, wherein a layer of PMMA, silane, or silicone dioxide isolates the region comprising the IDTs, one or more waveguides, and a coded reflector system from the fluid and allows for a rubber gasket around the perimeter of the region comprising the IDTs, waveguides, and reflectors of the integrated acoustic wave biosensor.

6. The disposable cartridge component of claim 1, wherein the disposable cartridge is configured to be paired with a cartridge reader

7. The integrated acoustic wave biosensor component of claim 1, wherein the integrated acoustic wave biosensor is a surface wave acoustic biosensor or a bulk wave acoustic biosensor.

8. The disposable cartridge component of claim 1, wherein the well leads to a fluid flow over the sensor in a single plex or multiplex format, optionally
wherein the well is an open well, or
wherein the well is a closed well.

9. (canceled)

10. (canceled)

11. The integrated acoustic wave biosensor component of claim 1, wherein the coded reflector system is of hyperbolic frequency modulation (HFM) or orthogonal frequency modulation (OFM) configuration.

12. The disposable cartridge component of claim 1, wherein the disposable cartridge further comprises two or three channel sensors or one or more multiplex sensor(s).

13. The integrated acoustic wave biosensor component of claim 1, wherein the coded reflector system comprises one or more metals, optionally wherein the one or more metals are selected from the group consisting of gold or aluminum.

14. (canceled)

15. The integrated acoustic wave biosensor component of claim 1, wherein unidirectional IDTs are used instead of the coded reflector system.

16. The disposable cartridge component of claim 1, wherein the disposable cartridge comprises a felt seal to protect the IDTs and the coded reflector system.

17. The integrated acoustic wave biosensor component of claim 1, wherein the one or more sensors are uniplex sensors or multiplex sensors,
optionally wherein the uniplex or multiplex sensors generate surface acoustic waves in the range of 50-1000 MHz or bulk acoustic waves in the range of 50-5,000 MHz, or
wherein the surface acoustic waves are in the range of 100-600 MHz, or
wherein the surface acoustic waves are in the range of 100-900 MHz.

18. (canceled)

19. (canceled)

20. (canceled)

21. The disposable cartridge component of claim 1, wherein the disposable well cartridge system has a wicking pad, optionally
wherein the disposable well is closed, or
wherein the disposable well is open.

22. (canceled)

23. (canceled)

24. The disposable cartridge component of claim 4, wherein the gasket is made of polymer or overmolded TPE onto the well, optionally wherein the polymer is PDMS, other silicone-based materials or other low durometer polymer materials.

25. (canceled)

26. A disposable cartridge component of an integrated acoustic wave biosensor system, the disposable cartridge component comprising:
a well for the addition of a fluid sample;
a cassette comprising an integrated acoustic wave biosensor, a galvanic connection assembly coupled to the integrated acoustic wave biosensor, and a sealing device separating the sensing area from the integrated acoustic wave biosensor; and
a docking location on the cassette body configured to couple with a well.

27. A method for detecting a target analyte in a biological sample using an integrated acoustic wave biosensor system of claim 1, the method comprising:
providing the fluid sample into the well;
applying surface acoustic waves to the sample in the well to generate a characteristic electrical signal of the biological sample; and
detecting the target analyte based on the characteristic electrical signal.

28. The integrated acoustic wave biosensor component of claim 1, wherein the biosensor comprises a sample channel and a reference channel and optionally comprising a compensation channel.

29. The integrated acoustic wave biosensor component of claim 1, wherein the acoustic wave biosensor has a metallic waveguide comprising one or more metals selected from the group consisting of gold, titanium, chromium, and aluminum.
